(19) United States
(12) Patent Application Publication
(10) Pub. No.: US 2016/0256777 A1
(43) Pub. Date: Sep. 8, 2016

(54) METHOD FOR CONTROLLING DISPLAY OF GAME IMAGE AND SERVER SYSTEM

(71) Applicant: BANDAI NAMCO Entertainment Inc., Tokyo (JP)

(72) Inventors: Yuko UMEBAYASHI, Yokohama-shi (JP); Akinori WAKEBE, Nagareyama-shi (JP)

(73) Assignee: BANDAI NAMCO Entertainment Inc., Tokyo (JP)

(21) Appl. No.: 15/059,887

(22) Filed: Mar. 3, 2016

(30) Foreign Application Priority Data
Mar. 5, 2015 (JP) 2015-043995

(51) Int. Cl. A63F 13/537; A63F 13/822

(52) U.S. Cl. CPC A63F 13/537; A63F 13/822

(57) ABSTRACT

When an icon included in a range display operation icon group has been operated using a position construction screen, a range display object is displayed corresponding to each battery that has been placed on a placement setting map, the range display object representing the effective range of an attack power linked to the icon that has been operated, and being displayed in an identifiable manner corresponding to the power of the battery. An overlapping area of a plurality of range display objects is also displayed in an identifiable manner.

Japanese Patent Application No. 2015-043995 filed on Mar. 5, 2015, is hereby incorporated by reference in its entirety.

### BACKGROUND

The present invention relates to image display control technology.

A video game that proceeds according to the arrangement of attack objects (that may be interchangeably referred to as “defense objects”) that have been placed by the user is known. Examples of such a game include a game that is referred to as “tower defense”, “defense game”, or the like. This type of game is hereinafter referred to as “tower defense game”. The tower defense game is designed so that the player places the desired characters on a map to defend the base from the enemies that attack the base, and the objects (characters) are automatically controlled. For example, JP-A-2015-8966 discloses technology relating to the tower defense game.

A game (e.g., tower defense game) that proceeds according to the arrangement of the attack objects that have been placed by the user may be designed so that, when the user (player) has selected the desired attack object among the attack objects that have been placed on the map, the attack range (i.e., effective range) of the attack object is displayed within the screen. In this case, the user can determine a weak area based on the display of the attack range, and determine the attack object that should be placed and the position at which the attack object should be placed.

According to the known attack range display method, however, it is difficult for the user to determine the overlapping area of the attack ranges of a plurality of attack objects. This is because the known attack range display method displays only the attack range of one of a plurality of attack objects that has been selected by the user. When the attack ranges of a plurality of attack objects are displayed at the same time, but the contour of each attack range is indicated by a line, it is necessary for the user to determine the overlapping area and the degree of overlap after determining whether the attack range is situated inside or outside the line that indicates the contour of the attack range. It may be relatively easy for the user to determine the attack range when only two attack ranges overlap each other. However, when it is desired to form an overlapping area of five or six attack ranges in order to defend an important base from the enemies, for example, it is very difficult for the user to determine all of the inside/outside of the range, the overlapping area, and the degree of overlap.

In particular, it is difficult for an inexperienced player and a junior player to make the above determination and the like. Specifically, it may be difficult for an inexperienced player and a junior player to obtain information for appropriately placing the attack object, and the difficulty level of the game may increase relatively. It is also difficult for an experienced player to make the above determination when the game field is wide and the number of attack objects is large.

### SUMMARY

According to one aspect of the invention, there is provided a method that causes a computer system to control display of a game image on a display device, the method comprising:

placing an attack object at a designated placement position within an object space according to a placement operation performed by a user;

displaying an effective range of an attack power of the attack object within the object space;

displaying an overlapping area of the effective ranges that respectively correspond to a plurality of the attack objects in an identifiable manner; and

performing a game control process according to an arrangement of the attack object.

According to another aspect of the invention, there is provided a server system that performs a game control process according to an arrangement of an attack object placed by a user according to an operation performed on a user terminal that is communicably connected thereto, and controls display of a game image on the user terminal, the server system comprising:

a placement section that places the attack object at a designated placement position within an object space according to a placement operation performed using the user terminal; and

a display control section that performs a control process that causes the user terminal to display an effective range of an attack power of the attack object within the object space, the display control section displaying an overlapping area of the effective ranges that respectively correspond to a plurality of the attack objects in an identifiable manner.

According to another aspect of the invention, there is provided a server system that performs a game control process according to an arrangement of an attack object placed by a user according to an operation performed on a user terminal that is communicably connected thereto, and controls display of a game image on the user terminal, the server system comprising:

placement means that places the attack object at a designated placement position within an object space according to a placement operation performed using the user terminal; and

display control means that performs a control process that causes the user terminal to display an effective range of an attack power of the attack object within the object space, the display control means displaying an overlapping area of the effective ranges that respectively correspond to a plurality of the attack objects in an identifiable manner.

### BRIEF DESCRIPTION OF THE DRAWINGS

FIG. 1 is a view illustrating an example of the configuration of a game system.

FIG. 2 is a perspective external view illustrating a configuration example of a player terminal.

FIG. 3 is a view illustrating an example of a game screen in a defense mode.

FIG. 4 is a view illustrating an example of a position construction screen that is displayed in a defense mode prior to the start of a game.

FIG. 5 is a view illustrating an example of the display of an effective range of an attack power.

FIG. 6 is a view illustrating an example of the display of a detailed display object.

FIG. 7 is a view illustrating an example of a game screen in a capture mode.

FIGS. 8A and 8B are views illustrating an example of the display of a safety zone.

FIG. 9 is a functional block diagram illustrating a functional configuration example of a server system.

FIG. 10 is a view illustrating an example of a program and data that are stored in a server storage section.

FIG. 11 is a view illustrating a data configuration example of stage-basis game initial setting data.

FIG. 12 is a view illustrating a data configuration example of user management data.

FIG. 13 is a view illustrating a data configuration example of play data.

FIG. 14 is a view illustrating a data configuration example of defense mode data.

FIG. 15 is a view illustrating a data configuration example of battery control data.

FIG. 16 is a view illustrating a data configuration example of capture mode data.

FIG. 17 is a flowchart illustrating the flow of a main process performed by a server system.

FIG. 18 is a flowchart illustrating the flow of a position construction process.

FIG. 19 is a flowchart illustrating the flow of an effective range display start process.

FIG. 20 is a view illustrating a modification of the display of an effective range.

### DESCRIPTION OF EXEMPLARY EMBODIMENTS

According to one embodiment of the invention, there is provided a method that causes a computer system to control display of a game image on a display device, the method comprising:

placing an attack object at a designated placement position within an object space according to a placement operation performed by a user;

displaying an effective range of an attack power of the attack object within the object space;

displaying an overlapping area of the effective ranges that respectively correspond to a plurality of the attack objects in an identifiable manner; and

performing a game control process according to an arrangement of the attack object.

According to another embodiment of the invention, there is provided a server system that performs a game control process according to an arrangement of an attack object placed by a user according to an operation performed on a user terminal that is communicably connected thereto, and controls display of a game image on the user terminal, the server system comprising:

a placement section that places the attack object at a designated placement position within an object space according to a placement operation performed using the user terminal; and

a display control section that performs a control process that causes the user terminal to display an effective range of an attack power of the attack object within the object space, the display control section displaying an overlapping area of the effective ranges that respectively correspond to a plurality of the attack objects in an identifiable manner.

According to another embodiment of the invention, there is provided a server system that performs a game control process according to an arrangement of an attack object placed by a user according to an operation performed on a user terminal that is communicably connected thereto, and controls display of a game image on the user terminal, the server system comprising:

placement means that places the attack object at a designated placement position within an object space according to a placement operation performed using the user terminal; and

display control means that performs a control process that causes the user terminal to display an effective range of an attack power of the attack object within the object space, the display control means displaying an overlapping area of the effective ranges that respectively correspond to a plurality of the attack objects in an identifiable manner.

According to this configuration, since it is possible to visually indicate the overlapping area of the effective ranges of the attack objects, it is possible to solve the above problems.

The method may further comprise:

changing a size of the effective range corresponding to a range of the attack object.

The method may further comprise:

displaying the effective range in an identifiable manner corresponding to one of a type of the attack object, compatibility of the attack object with an attack target, an attack attribute assigned to the attack object, and an attack quantity assigned to the attack object, the type, the compatibility, the attack attribute, and the attack quantity being hereinafter referred to as “type or the like”.

The method may further comprise:

displaying an area of the effective range other than the overlapping area corresponding to the type or the like of the attack object, and displaying the overlapping area corresponding to the type or the like of the attack object that corresponds to the overlapping area.

The method may further comprise:

selecting the attack object; and

displaying the effective range of only the selected attack object.

The method may further comprise:

selecting the attack object; and

displaying the effective range of only the selected attack object corresponding to the type or the like of the selected attack object.

According to this configuration, it is possible to display the overlapping area of the effective ranges as well as the effective ranges in an identifiable manner while reflecting various types of information.

The method may further comprise:

controlling display of the object space in which the attack object has been placed by a first user based on a display instruction operation performed by a second user.

According to this configuration, it is possible to display the effective range and the like in an identifiable manner in accordance with the request by the second user other than the first user who has placed the attack object. Therefore, it is possible to further improve the attraction of the game.

The method may further comprise:

displaying the effective range, or displaying the overlapping area in an identifiable manner, or displaying the effective range and displaying the overlapping area in an identifiable manner in exchange for consumption of given points possessed by the user.

The method may further comprise:

changing a quantity of the points to be consumed corresponding to a number of the attack objects to be displayed or a type of the attack object to be displayed.

According to this configuration, it is possible to charge the user for the display of the effective range.

Exemplary embodiments to which the invention is applied are described below taking a tower defense game (i.e., online game) as an example.

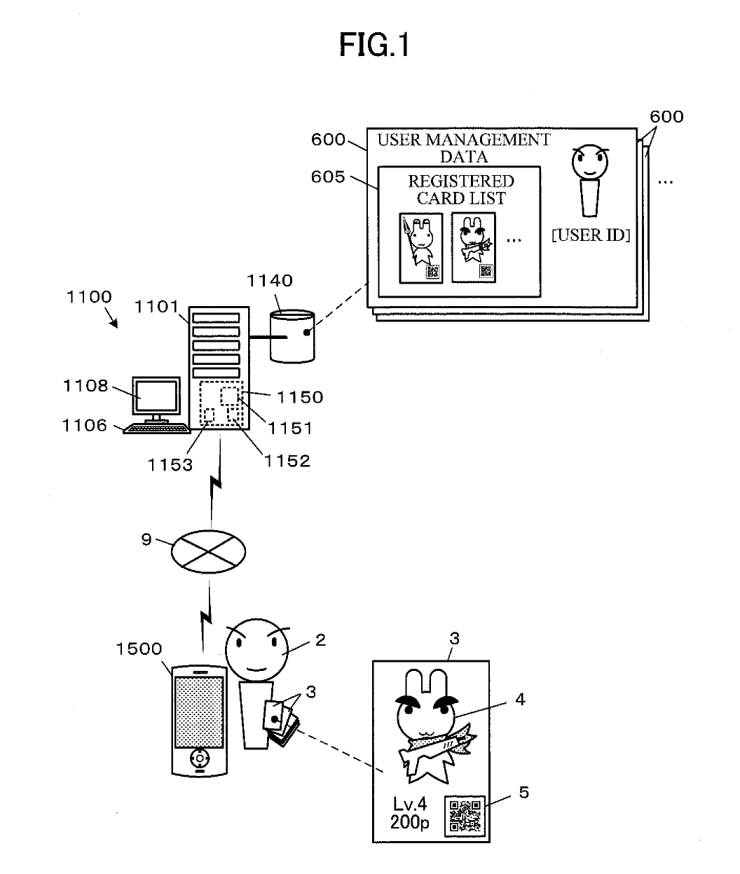

FIG. 1 is a view illustrating an example of the configuration of a game system according to one embodiment of the invention. The game system according to one embodiment of the invention includes a server system 1100 that can connect to a communication line 9, and a player terminal 1500 that can exchange data with the server system 1100.

The communication line 9 is a data communication channel. Specifically, the communication line 9 includes a communication network such as a local area network (LAN) using a private line (private cable) for direct connection, Ethernet (registered trademark), and the like, a telecommunication network, a cable network, and the Internet. The communication method may be either or both of a cable communication method and a wireless communication method.

The server system 1100 includes a main device 1101, a keyboard 1106, a touch panel 1108, and a storage 1140, for example. The main device 1101 includes a control board 1150. The control board 1150 is provided with a microprocessor (e.g., central processing unit (CPU) 1151, graphics processing unit (GPU), and digital signal processor (DSP)), an IC memory 1152 (e.g., VRAM, RAM, and ROM), and a communication device 1153. Note that part or the entirety of the control board 1150 may be implemented by an application-specific integrated circuit (ASIC), a field-programmable gate array (FPGA), or a system-on-a-chip (SoC).

The server system 1100 is configured so that the control board 1150 performs a calculation process based on a given program and data to implement 1) a user management function (e.g., user registration function), 2) a game management function that provides data necessary for the player (i.e., user) to play the game using the player terminal 1500, and 3) an online shopping function that sells contents (e.g., item) that can be used in the game. Specifically, the video game according to one embodiment of the invention is implemented as a client-server online game.

In the example illustrated in FIG. 1, the server system 1100 is provided as a single server system. Note that the server system 1100 may have a configuration in which a plurality of blade servers that take charge of part of the user management function, the online shopping function, and the game management function are provided, and connected to each other so as to be able to exchange data communication through an internal bus. Alternatively, the functions of the server system 1100 may be implemented by causing a plurality of independent servers provided in remote locations to exchange data through the communication line 9.

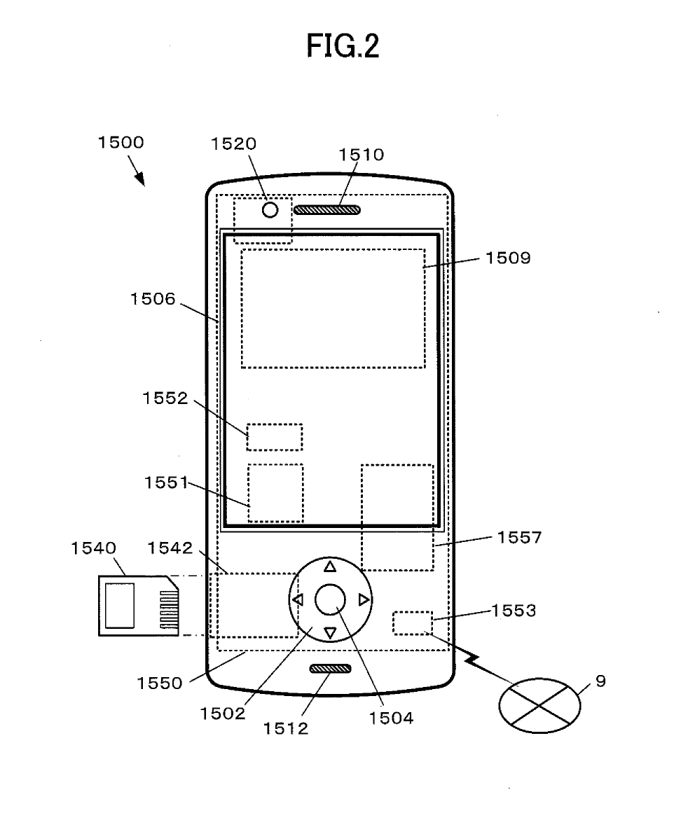

FIG. 2 is a front external view illustrating a configuration example of the player terminal 1500.

The player terminal 1500 is a mobile computer (small electronic device) that can connect to the communication line 9 and access the server system 1100. The player terminal 1500 according to one embodiment of the invention is a device that is classified as a smartphone. Note that the player terminal 1500 may be a device that is classified as a portable game device, a stationary consumer game device, a game controller of a stationary consumer game device, an arcade game device, a personal computer, a tablet computer, a wearable computer, or the like.

The player terminal 1500 according to one embodiment of the invention includes an arrow key 1502, a button switch 1504, a touch panel 1506 that functions as an image display device and a touch position input device, a built-in battery 1509, a speaker 1510, a microphone 1512, an image sensor unit 1520, a control board 1550, and a memory card reader 1542 that can read and write data from and into a memory card 1540 (i.e., computer-readable storage medium). The player terminal 1500 also includes a power button, a volume control button, and the like (not illustrated in FIG. 2). The player terminal 1500 may include an IC card reader that can read and write data from and into an IC card (e.g., credit card or prepaid card) in a non-contact manner, for example. Note that the player terminal 1500 according to one embodiment of the invention has an external appearance that is longer than it is wide, and the touch panel 1506 that has an aspect ratio other than 1:1 is provided so that the long side thereof extends along the longitudinal direction of the player terminal 1500.

The control board 1550 is provided with a microprocessor (e.g., CPU 1551, GPU, and DSP), an IC memory 1552 (e.g., VRAM, RAM, and ROM), and a wireless communication module 1553 that communicates with a mobile phone base station, a wireless LAN base station, or the like that connects to the communication line 9 via wireless communication. The control board 1550 also includes an interface (I/F) circuit 1557 such as a driver circuit that drives the touch panel 1506, a circuit that receives signals from the arrow key 1502 and the button switch 1504, an output amplifier circuit that outputs a sound signal to the speaker 1510, an input signal generation circuit that generates a signal from the sound collected by the microphone 1512, a circuit that receives image data that has been captured and generated by the image sensor unit 1520, and a signal input-output circuit that exchanges a signal with the memory card reader 1542. The elements provided to the control board 1550 are electrically connected to each other through a bus circuit or the like so that the elements can exchange data and signals. Note that part or the entirety of the control board 1550 may be implemented by an application-specific integrated circuit (ASIC), a field-programmable gate array (FPGA), or a system-on-a-chip (SoC).

The control board 1550 stores a program and data necessary for implementing game play using the player terminal 1500 in the IC memory 1552. The control board 1550 executes the program to perform a calculation process, and controls each section of the player terminal 1500 based on an operation input performed using the arrow key 1502, the button switch 1504, and the touch panel 1506 to implement game play. In one embodiment of the invention, the player terminal 1500 acquires a necessary program and setting data from the server system 1100. Note that the player terminal 1500 may read a necessary program and the like from a storage medium such as the memory card 1540.

Again referring to FIG. 1, the player (player 2) who desires to play the game according to one embodiment of the invention obtains a game card 3 in advance. The player registers himself/herself as a user to acquire a user ID (account). The player performs a card registration process (that makes it possible to use the game card 3 in the game) using the acquired user ID, and plays the game using the registered game card 3 (i.e., data (e.g., character 4) that is linked to the game card 3).

The player registers himself/herself as a user by accessing a website provided by the server system 1100, and going through a given process. When the player has registered himself/herself as a user, the user ID (account (ID specific to each player)) is provided to the player. The player can play the game or do online shopping or the like by accessing the website, and logging into the website using the user ID.

The game card 3 is an element necessary for playing the game according to one embodiment of the invention (i.e., game play element), and forms part of the game contents.

The game card 3 is provided by the game producer. The game card 3 may be a tangible card (i.e., trading card), or may be a virtual (intangible) card that includes only electronic information. When the game card 3 is a tangible card, a given number of cards (e.g., two cards or five cards) are sold in the actual store as a package. When the game card 3 is a virtual card, a given number of cards may be assigned to the player by lottery each time the player logs in or uses a lottery right obtained separately. It is also possible to employ a configuration in which the player can purchase the game card 3 on an online shopping site implemented by the server system 1100, or a known online shopping site.

In one embodiment of the invention, one character 4 is assigned to one game card 3. One type of character 4 is assigned to a plurality of game cards 3. Therefore, a specific card ID is assigned to each game card 3, and displayed using a barcode 5.

When the player has registered himself/herself as a user, user management data 600 that is linked to the user ID is generated by the server system 1100 (e.g., stored in the storage 1140). When the player 2 has performed the card registration process using the card ID of the desired game card 3, the card ID of the game card 3 that has been registered is registered in a registered card list 605 included in the user management data 600. The character 4 linked to the registered game card 3 can thus be used in the game.

Note that the game play element is not limited to a card. An arbitrary element may be used as the game play element. For example, a three-dimensional object that imitates a character, an item, or the like may be used as the game play element. In this case, the game play element may be designed to be an item for collection in terms of size, design, and the like.

### Details of Game

The game according to one embodiment of the invention is an online game that is classified as the tower defense game, and designed so that the player can play the game in a defense mode or a capture mode. The defense mode is a play mode in which the player constructs a position, and tries to defend the position from an enemy's invasion. The capture mode is a play mode in which the player tries to capture a position constructed by another player using the character 4 assigned to the registered game card 3 as an invasion object. An example in which the player battles with a computer (player-versus-computer (PvC) mode) is described below. Note that a player-versus-player (PvP) mode may also be used.

The defense mode is described below.

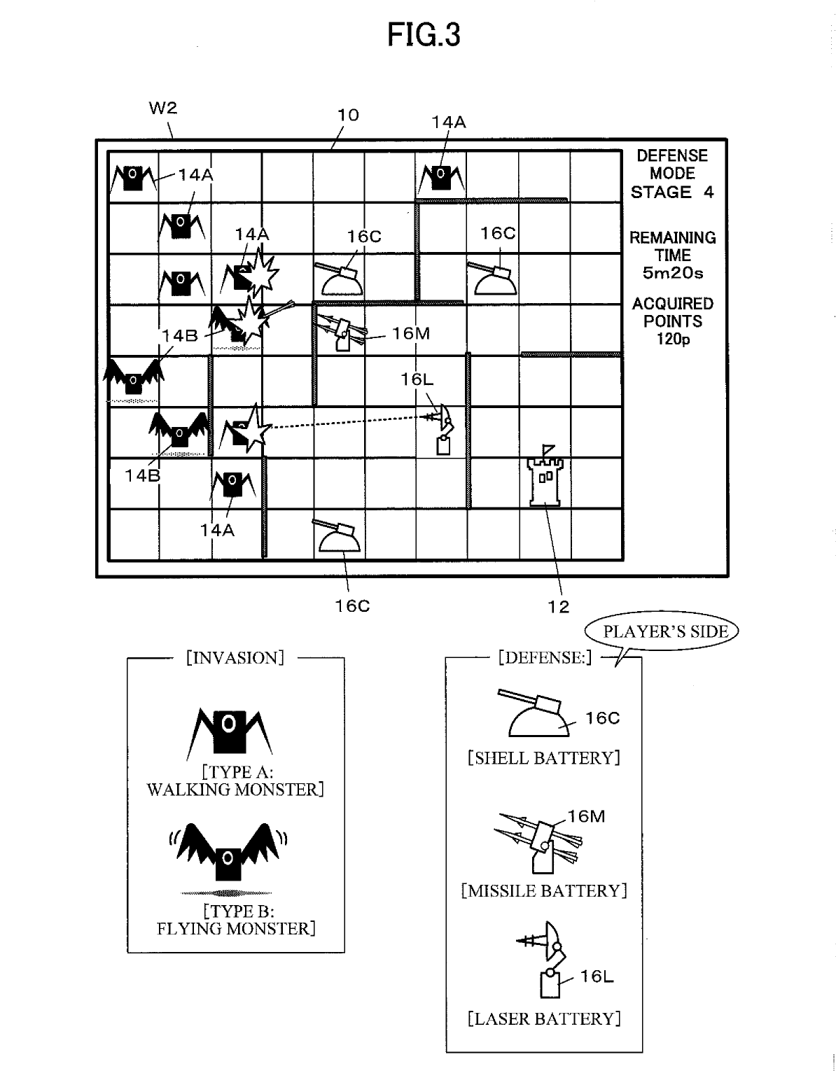

FIG. 3 is a view illustrating an example of the game screen in the defense mode.

In the defense mode, the player can select the desired game stage (game field) prior to the start of the game. Various geographical features are set to a map 10 that corresponds to the game stage. In the defense mode, the map 10 occupies the majority of a game screen W2.

A player's base 12 is set to the map 10 in advance. Enemies 14 appear one after another when the game has started, and attack the base 12. The player constructs a position prior to the start of the game by placing batteries 16 in arbitrary locations on the map 10 to battle with the enemies 14. The battery 16 is an example of a bombardment object (attack object (may be referred to as “defense object” taking account of the game)).

Various types of enemies 14 (enemy types) that differ in moving capability, action pattern, attack capability, defense capability, moving speed, attack method, and the like are provided, and the movement and the attack action of each enemy 14 are automatically controlled by the computer. In one embodiment of the invention, the enemies 14 include at least a walking-type enemy 14A and a flying-type enemy 14B. Note that the enemy types are not limited thereto. Other types of enemies 14 such as a floating-type enemy, a diving-type enemy, a burrowing-type enemy, and summon beast-type enemy may be appropriately provided corresponding to the details of the game, the stage configuration, and the like.

The battery 16 is automatically controlled by the computer with regard to the search action, the sight action, and the attack action. An attack power that corresponds to the type of enemy 14 is set to the battery 16. A plurality of batteries 16 that are identical in type, but differ in capability (e.g., range, damage range, firing cycle, number of shells to be fired, or number of shells that can be loaded) are provided. The difference in capability is represented by the level of the battery 16. The level is an example of a grade.

A ground attack capability and a ground attack power are set to the battery 16 corresponding to the type of enemy 14. A shell battery 16C that specializes in ground attack, a missile battery 16M that specializes in anti-aircraft attack, and a laser battery 16L that has a ground attack capability and an anti-aircraft attack capability are provided. A plurality of shell batteries 16C that differ in level, a plurality of missile batteries 16M that differ in level, and a plurality of laser batteries 16L that differ in level, are provided. Note that the type of attack power provided to each battery 16 may be appropriately set corresponding to the game. For example, an anti-submarine attack power (i.e., an attack power with respect to a diving enemy 14), an anti-magic attack power (i.e., an attack power with respect to an enemy 14 that uses magic), and the like may be appropriately set corresponding to the type of enemy 14.

The enemy 14 and the battery 16 can attack each other. Each of the enemy 14 and the battery 16 is disabled (i.e., defeated) when the damage applied due to attack exceeds the durability value.

The player 2 loses the game (i.e., game over) when the enemy 14 has reached the base 12. The player 2 wins the game (i.e., game clear) when the player 2 has held out against the invasion by the enemies 14 for a given time, or has defeated all of the enemies 14. The play result is determined based on whether the player 2 has lost or won the game, and the number and the types of enemies 14 that have been defeated until the player 2 loses or wins the game. Specifically, the key to win the game is to place appropriate batteries 16 at effective defense points taking account of the action pattern of each type of enemy 14.

In the defense mode, the player must construct a position prior to the start of the game by selectively placing batteries 16 (see above).

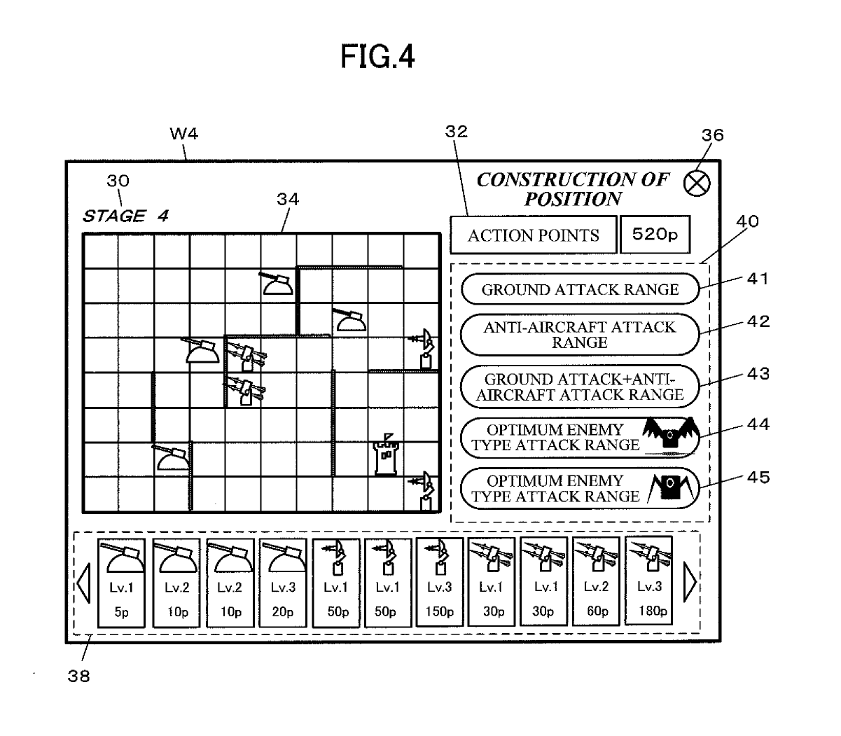

FIG. 4 is a view illustrating an example of a position construction screen that is displayed in the defense mode prior to the start of the game.

A position construction screen W4 includes a stage ID display 30 that represents the game stage to be played, an action point display 32, a placement setting map 34 that represents the state of an object space in which the batteries 16 are placed, a position construction completion operation icon 36, a deck 38, and a range display operation icon group 40.

A plurality of placeable elements (batteries 16) that can be placed (used) by the player in the game stage are displayed within the deck 38 so that the player can select the desired placeable element. In one embodiment of the invention, each placeable element is displayed in the shape of a card.

The player selects the desired placeable element from the placeable elements displayed within the deck 38 by performing a touch operation, and moves the selected placeable element to the desired position on the placement setting map 34 by performing a drag-and-drop operation. The player can thus place the desired placeable element at the desired position on the corresponding map 10. Note that the player can change the placement position of the placeable element placed on the placement setting map 34 by performing a drag-and-drop operation within the position construction screen W4.

A placement cost is set to each placeable element corresponding to the power and the degree of growth of the placeable element. The player can place the desired placeable elements at arbitrary positions within the range of the action points possessed by the player. The action points possessed by the player are always displayed within the action point display 32.

The range display operation icon group 40 includes icons for performing a display start operation/display stop operation on the effective range of the battery 16 that has been placed on the placement setting map 34. One type of icon or a plurality of types of icons are provided corresponding to the type of attack power set to the battery 16, and the type of enemy 14 that appears in the game stage.

In one embodiment of the invention, the battery 16 has the ground attack power and the anti-aircraft attack power that differ in attack attribute. Therefore, the range display operation icon group 40 includes a ground attack range display operation icon 41 for displaying the effective range of the ground attack power, an anti-aircraft attack range display operation icon 42 for displaying the effective range of the anti-aircraft attack power, and a ground attack+anti-aircraft attack range display operation icon 43 for displaying both the effective range of the ground attack power and the effective range of the anti-aircraft attack power. In one embodiment of the invention, the enemies 14 include a flying-type enemy 14 and a walking-type enemy 14. Therefore, the range display operation icon group 40 includes a first optimum enemy type attack range display operation icon 44 and a second optimum enemy type attack range display operation icon 45 that are respectively linked to the flying-type enemy 14 and the walking-type enemy 14. The optimum enemy type attack range display operation icon is preferably provided corresponding to the enemy type. Note that the optimum enemy type attack range display operation icon may be provided corresponding to a plurality of enemy types that are similar in attack power.

When the player has touched the ground attack range display operation icon 41, the anti-aircraft attack range display operation icon 42, or the ground attack+anti-aircraft attack range display operation icon 43, the effective range of the attack power to which the ground attack range display operation icon 41, the anti-aircraft attack range display operation icon 42, or the ground attack+anti-aircraft attack range display operation icon 43 is linked, is displayed. When the player has touched the ground attack range display operation icon 41, the anti-aircraft attack range display operation icon 42, or the ground attack+anti-aircraft attack range display operation icon 43 again, the display of the effective range is canceled.

When the player has touched the first optimum enemy type attack range display operation icon 44 or the second optimum enemy type attack range display operation icon 45, the attack power that is suitable for the enemy type that is linked to the first optimum enemy type attack range display operation icon 44 or the second optimum enemy type attack range display operation icon 45 is automatically selected from the ground attack power, the anti-aircraft attack power, and the ground attack+anti-aircraft attack power, and the effective range of the automatically selected attack power is displayed. When the player has touched the first optimum enemy type attack range display operation icon 44 or the second optimum enemy type attack range display operation icon 45 again, the display of the effective range is canceled. In other words, the ground attack power, the anti-aircraft attack power, the ground attack+anti-aircraft attack power, and the like represent the compatibility with the attack target.

In the example illustrated in FIG. 4, the flying-type enemy 14 is linked to the first optimum enemy type attack range display operation icon 44, and the anti-aircraft attack power that is suitable for the flying-type enemy 14 is automatically selected (so that it is possible to effectively damage the flying-type enemy 14) when the player has touched the first optimum enemy type attack range display operation icon 44.

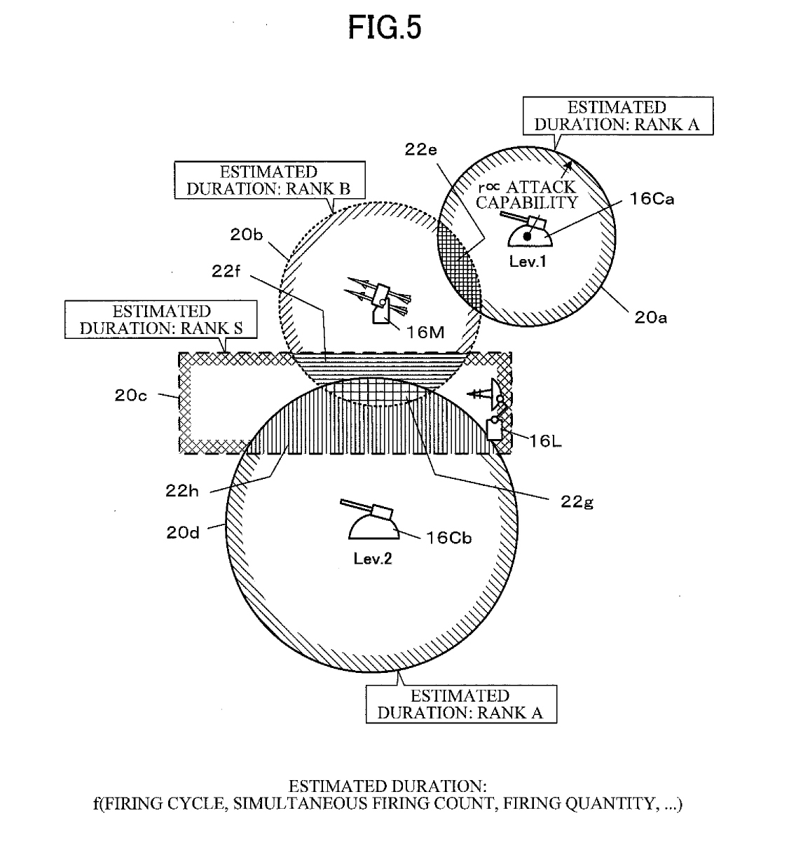

FIG. 5 is a view illustrating an example of the display of the effective range of the attack power.

The batteries 16 that differ in type differ in ground attack capability and anti-aircraft attack capability even if the level is identical. The batteries 16 may also differ in range and range shape with respect to the attack power. The range shape can be appropriately set (e.g., circular shape, elliptical shape, polygonal shape, fan-like shape, or scattered shape). Note that the range shape is not limited to a two-dimensional shape, but may be a three-dimensional shape. A range display object 20 (20a, 20b, . . . ) is displayed corresponding to each battery 16 displayed on the placement setting map 34 based on the attack power and the range shape.

The shape of the contour of the range display object 20 (20a, 20b, . . . ) is identical to the range shape that is set corresponding to the type of battery 16. The size of the range display object 20 (20a, 20b, . . . ) is changed corresponding to the range that is set to the battery 16. The size of the range display object 20 (20a, 20b, . . . ) is increased as the range increases. In the example illustrated in FIG. 5, a low-level shell battery 16Ca is disposed on the upper side, and a high-level shell battery 16Cb is disposed on the lower side. Since the shell battery 16Ca and the shell battery 16Cb are identical in type, the range display object 20a that is displayed corresponding to the shell battery 16Ca and the range display object 20d that is displayed corresponding to the shell battery 16Cb have a similar shape. However, since the range is increased as the level increases, the range display object 20d is displayed to be larger than the range display object 20a.

The display color of the range display object 20 is set corresponding to the attack power that is represented by the range display object 20. In one embodiment of the invention, the range display object 20 that corresponds to the anti-aircraft attack power is displayed in blue, and the range display object 20 that corresponds to the ground attack power is displayed in red. The color depth is set corresponding to the attack power value. When the effective range is displayed corresponding to a plurality of types of attack power, the range display object 20 is displayed in a color obtained by mixing the colors that respectively correspond to the plurality of types of attack power. Note that the display color may be applied to only part (e.g., contour) of the range display object 20 (see FIG. 5), or may be applied to the entirety of the range display object 20. The display color may be a semi-transparent color.

The outline of the range display object 20 is determined corresponding to the estimated duration of the attack power that is set to the battery 16. In one embodiment of the invention, the estimated duration is calculated by a given function f using the firing cycle, the simultaneous firing count, and the firing quantity (i.e., the number of shells) (i.e., capability parameter values) that are set to the battery 16 as variables. Note that a capability parameter value other than these capability parameter values can also be used as a variable. For example, when a time limit is set to the power of the battery 16, the time limit may be used as a variable. The estimated duration is ranked according to the classification that is set in advance, and the display state is set corresponding to the rank.

An area in which a plurality of range display objects 20 (20a, 20b, . . . ) overlap each other (i.e., overlapping area 22 (22e, 22f, 22g, 22h, . . . ) is displayed in an identifiable manner corresponding to the combination of the plurality of range display objects 20 that overlap each other. The overlapping area 22 may be displayed in an identifiable manner using an appropriate method. In one embodiment of the invention, the overlapping area 22 is displayed using a combination of the display colors of a plurality of range display objects 20 that overlap each other. For example, the overlapping area 22 is displayed in a color obtained by additive color mixing, or displayed in stripes using the display colors of a plurality of range display objects 20 that overlap each other. Alternatively, the overlapping area 22 may be displayed to blink.

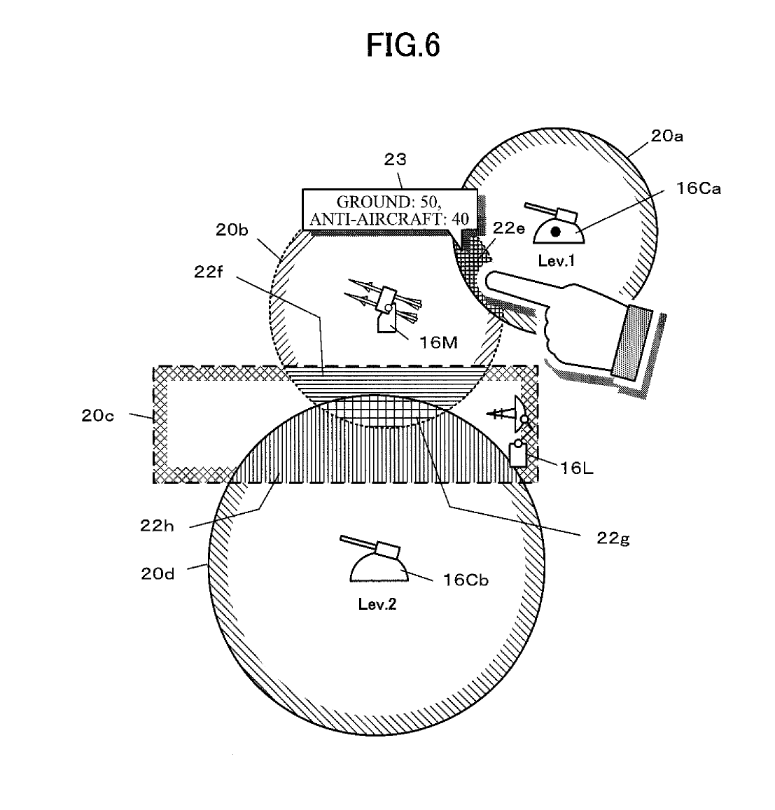

As illustrated in FIG. 6, when the player has touched (selected) the range display object 20 (20a, 20b, . . . ) or the overlapping areas 22 (22e, 22f, 22g, 22h, . . . ), the parameter values (e.g., attack power and duration) that correspond to the range display object or the overlapping area are displayed using a pop-up detailed display object 23.

When the range of only one battery 16 can be displayed, or when the ranges of a plurality of batteries 16 can be displayed, but the contour of each range is merely drawn using a line, it is difficult for the player to visually determine the overlapping range and the degree of overlap. According to one embodiment of the invention, each overlapping area 22 can be displayed in an identifiable manner, and it is possible for the player to easily determine the outside and the inside of the range due to the outline having a strip-like shape. Since it is possible to determine the degree of overlap, the player can easily determine a strongly defended area within the position. In other words, the player can easily determine a weakly defended area within the position.

It is also possible for the player to determine the attack power represented by the range display object 20 and the overlapping area 22, the degree of the attack power, and the duration of the attack power from the display state of the range display object 20 and the overlapping area 22.

The capture mode is described below.

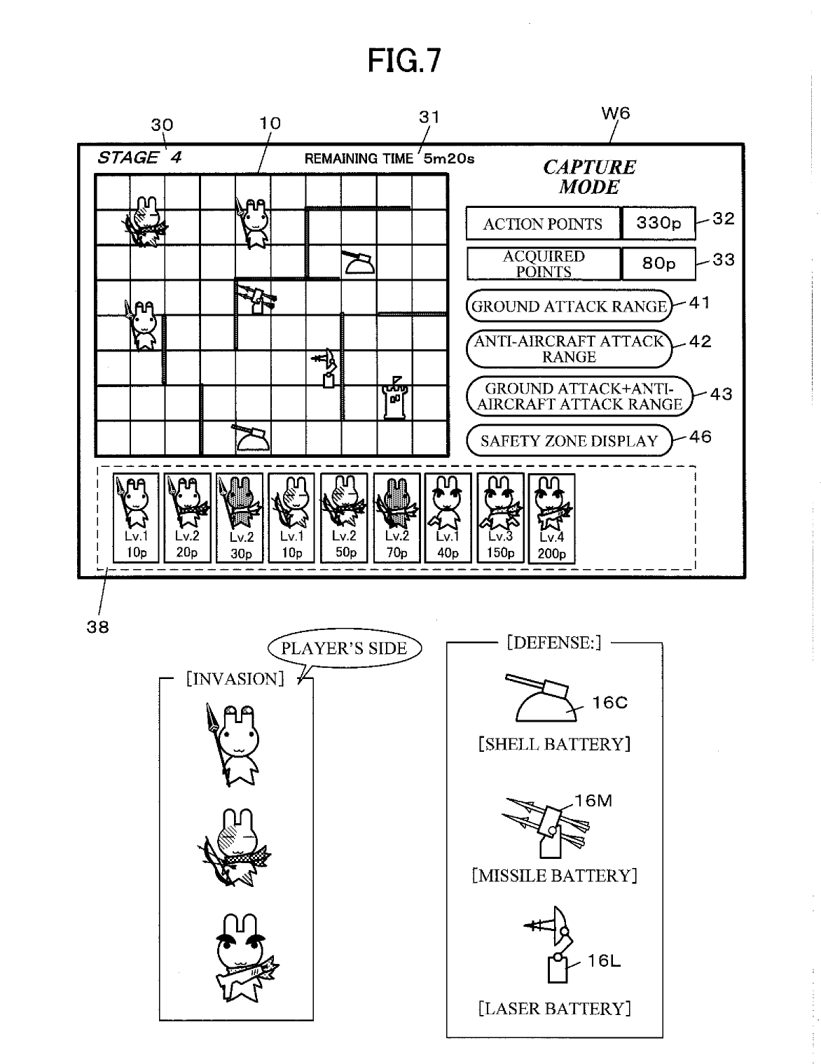

FIG. 7 is a view illustrating an example of the game screen in the capture mode.

A capture mode game screen W6 includes a map 10, a stage ID display 30, a remaining time display 31, an action point display 32, an acquired point display 33, a deck 38, a ground attack range display operation icon 41, an anti-aircraft attack range display operation icon 42, a ground attack+anti-aircraft attack range display operation icon 43, and a safety zone display operation icon 46.

A map that is included in the data selected by the player prior to the start of the game from the position construction data generated by another player when playing the game in the defense mode is used as the map 10 used in the capture mode.

The characters 4 that are linked to the game cards 3 registered by the player are displayed within the deck 38 as placeable elements. A placement cost is set to each character 4, and each character 4 is placed in exchange for the consumption of the action points. When the game has started, the player places the desired character 4 on the map 10 as an invasion object within the points displayed on the action point display 32.

The functions of the action point display 32, the acquired point display 33, the deck 38, the ground attack range display operation icon 41, the anti-aircraft attack range display operation icon 42, and the ground attack+anti-aircraft attack range display operation icon 43 are the same as described above in connection with the defense mode. Specifically, the range display object 20 and the overlapping area 22 can be displayed on the map 10.

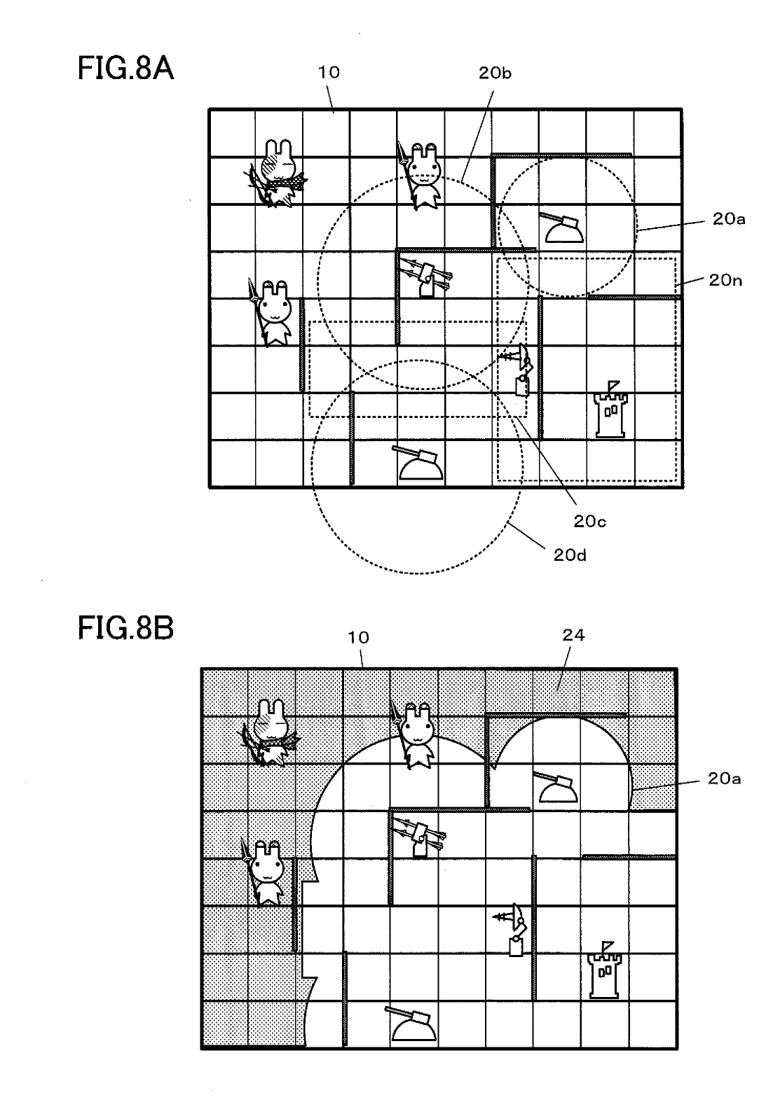

The safety zone display operation icon 46 is an icon specific to the capture mode. The safety zone display operation icon 46 is used to perform an operation input for starting/stopping the display of a safety zone in which the character 4 can be placed without being subjected to the attack by the battery 16. When the player has touched the safety zone display operation icon 46, the range display object 20 (20a, 20b, 20c, 20d) of each battery 16 and a range 20n in which the character 4 cannot be placed according to the game rules are determined (see FIG. 8A), and an area other than the range display object 20 and the range 20n is displayed on the map 10 as a safety zone display 24 (shaded area in FIG. 8B) (see FIG. 8B).

Note that the safety zone display operation icon 46 may also be displayed in the defense mode.

### Functional Configuration

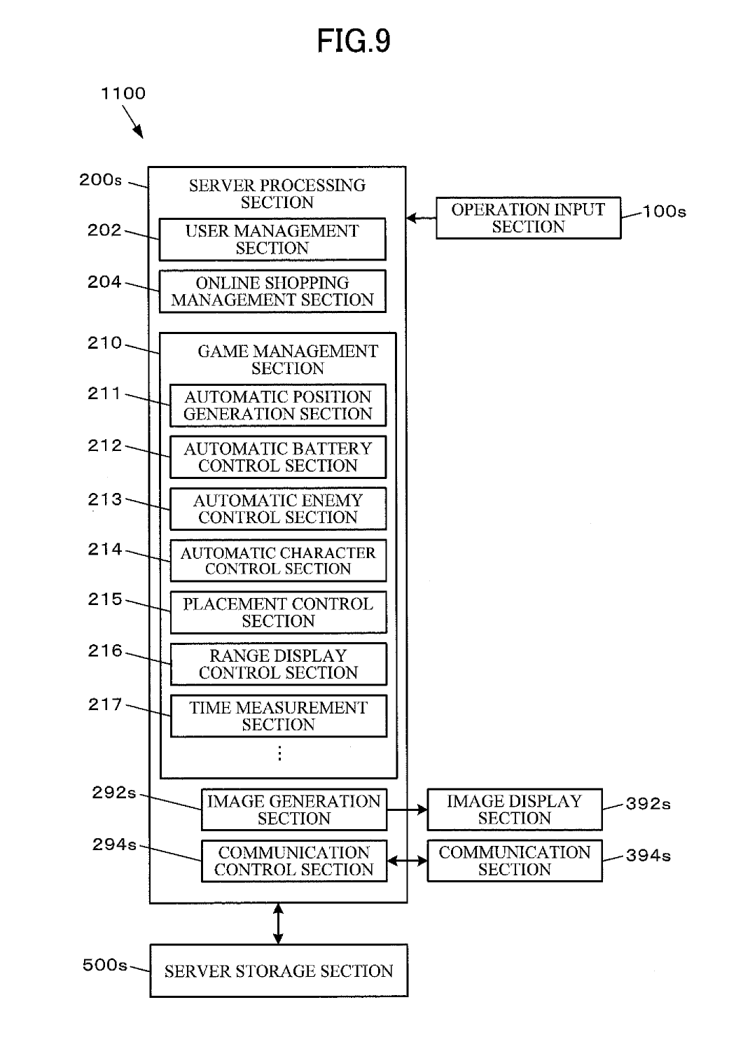

FIG. 9 is a functional block diagram illustrating an example of the functional configuration of the server system 1100 according to one embodiment of the invention. The server system 1100 according to one embodiment of the invention includes an operation input section 100s, a server processing section 200s, an image display section 392s, a communication section 394s, and a server storage section 500s.

The operation input section 100s is a means for performing an operation input for managing the server system 1100. In the example illustrated in FIG. 1, the keyboard 1106 corresponds to the operation input section 100s.

The server processing section 200s is implemented by electronic parts such as a microprocessor (e.g., CPU and GPU) and an IC memory. The server processing section 200s performs a data input-output control process on each functional section including the operation input section 100s and the server storage section 500s. The server processing section 200s performs various calculation processes based on a given program, data, an operation input signal from the operation input section 100s, and data received from the player terminal 1500. In the example illustrated in FIG. 1, the control board 1150 corresponds to the server processing section 200s.

The server processing section 200s according to one embodiment of the invention includes a user management section 202, an online shopping management section 204, a game management section 210, an image generation section 292s, and a communication control section 294s.

The user management section 202 performs a user registration process, and performs a registration-management process on various types of data linked to the registered user.

For example, the user management section 202 may perform 1) a process that provides a specific user ID to the user (player) who has performed a given registration process, 2) a game card registration process, 3) an electronic payment medium link process, 4) an electronic payment account setting process, 5) an account payment process using cash or a credit card, 6) a payment process (e.g., payment of play fee), 7) a payment history storage-management process, and the like.

The online shopping management section 204 is a functional section that implements the online purchase of the placeable element (e.g., battery 16 and character 4), the action points, an item that adds power to the placeable element, a lottery right, an event participation right, and the like. The online purchase may be implemented in the same manner as known online shopping.

The game management section 210 performs various game play-related processes.

When implementing a client-server online game, the game management section 210 performs a control process that starts the game according to one embodiment of the invention upon reception of an execution request from the player terminal 1500, and provides data necessary for game play to the player terminal 1500 while communicating with the player terminal 1500.

For example, the game management section 210 performs a play preparation process that receives the selection of the game mode, the selection of the game stage, and the selection-placement operation for constructing a position corresponding to an operation input from the player terminal 1500. The game management section 210 may also perform a process that automatically controls the enemy 14, the battery 16, and the character 4, an attack hit determination process, a damage reflection process, a time measurement process, and a game play result determination process. The game management section 210 may appropriately perform a process that manages a flag necessary for the game process, a data decoding process, and the like depending on the game.

When a growth element is assigned to the battery 16 or the character 4 that has been used, the game management section 210 may perform a process that causes the battery 16 or the character 4 to grow corresponding to the game result, a process that stores the data that represents the placeable element that has grown, and the like.

When implementing the game in a PvP mode, the game management section 210 may be provided with a player matching function. When implementing the game in a PvP mode, the offense and the defense may be switched alternately, or only an operation input performed by the offense-side player to attack the defense-side player's position construction data may be received.

The game management section 210 according to one embodiment of the invention includes an automatic position generation section 211, an automatic battery control section 212, an automatic enemy control section 213, an automatic character control section 214, a placement control section 215, a range display control section 216, and a time measurement section 217.

The automatic position generation section 211 automatically generates the defense-side position when the position data (that can be selected) does not exist when the player plays the game in the capture mode.

The automatic battery control section 212, the automatic enemy control section 213, and the automatic character control section 214 automatically control the battery 16, the enemy 14, and the character 4, respectively.

The placement control section 215 performs a position construction process in the defense mode. Specifically, the placement control section 215 displays the position construction screen W4 on the player terminal 1500, and places the battery 16 (bombardment object) at the designated placement position on the map 10 (object space) according to the placement operation performed by the player (user). The placement results are obtained as position configuration data.

The range display control section 216 performs a display control process that controls the display of the range display object 20, the overlapping area 22, and the safety zone display 24. Specifically, the range display control section 216 performs a display control process that controls the display of the effective range of the attack power of the battery 16 (bombardment object) on the placement setting map 34 (object space) within the position construction screen W4 (see FIG. 4), or the map 10 (object space) within the capture mode game screen W6 (see FIG. 7). Note that the display control process performed by the range display control section 216 is a display control process performed on the player terminal 1500. The range display control section 216 displays the overlapping area 22 of the effective ranges of a plurality of batteries 16 in an identifiable manner.

More specifically, the range display control section 216 changes the size of the range display object 20 (effective range) corresponding to the range of the battery 16 (bombardment object).

The range display control section 216 changes the contour shape, the display color, and the outline (contour zone display object) of the range display object 20 and the overlapping area 22 corresponding to the type of battery 16, the optimum enemy type corresponding to the type of battery 16, the shell attribute, the firing quantity, and the like. The range display control section 216 can display the overlapping area 22 in a mixed color corresponding to the type of battery 16 and the like.

The range display control section 216 can display the range display object 20 and the overlapping area 22 of the battery 16 (bombardment object) corresponding to the optimum enemy type designation operation (i.e., an operation that touches the first optimum enemy type attack range display operation icon 44 or the second optimum enemy type attack range display operation icon 45 illustrated in FIG. 4).

In the capture mode, the range display control section 216 performs a display control process on the position configuration (i.e., the object space (map 10) in which the batteries 16 are placed) formed by another user based on the display instruction operation (i.e., an operation that touches the safety zone display operation icon 46 illustrated in FIG. 7) performed by the player who plays the game in the capture mode.

The image generation section 292s is implemented by a processor (e.g., GPU and digital signal processor (DSP)), a video signal IC, a program (e.g., video codec), a drawing frame IC memory (e.g., frame buffer), or the like. The image generation section 292s generates data for displaying the game screen (image) on the player terminal 1500 based on the processing results of the game management section 210. The image generation section 292s generates an image necessary for the system management process, and outputs the image signal to the image display section 392s.

The image display section 392s displays various images necessary for the system management process based on the image signal input from the image generation section 292s. For example, the image display section 392s may be implemented by an image display device such as a flat panel display, a cathode-ray tube (CRT), a projector, or a head-mounted display. In the example illustrated in FIG. 1, the touch panel 1108 corresponds to the image display section 392s.

The communication control section 294s performs a data communication process, and exchanges data with an external device through the communication section 394s.

The communication section 394s connects to the communication line 9 to implement communication. The communication section 394s is implemented by a transceiver, a modem, a terminal adapter (TA), a jack for a communication cable, a control circuit, and the like. In the example illustrated in FIG. 1, the communication device 1153 corresponds to the communication section 394s.

The server storage section 500s stores a system program that causes the server processing section 200s to control the server system 1100, a game management program, various types of data, and the like. The server storage section 500s is used as a work area for the server processing section 200s, and temporarily stores the results of calculations performed by the server processing section 200s according to various programs. The function of the server storage section 500s is implemented by an IC memory (e.g., RAM and ROM), a magnetic disk (e.g., hard disk), an optical disk (e.g., CD-ROM and DVD), an online storage, or the like. In the example illustrated in FIG. 1, the storage medium (e.g., IC memory 1152 and hard disk) and the storage 1140 correspond to the server storage section 500s.

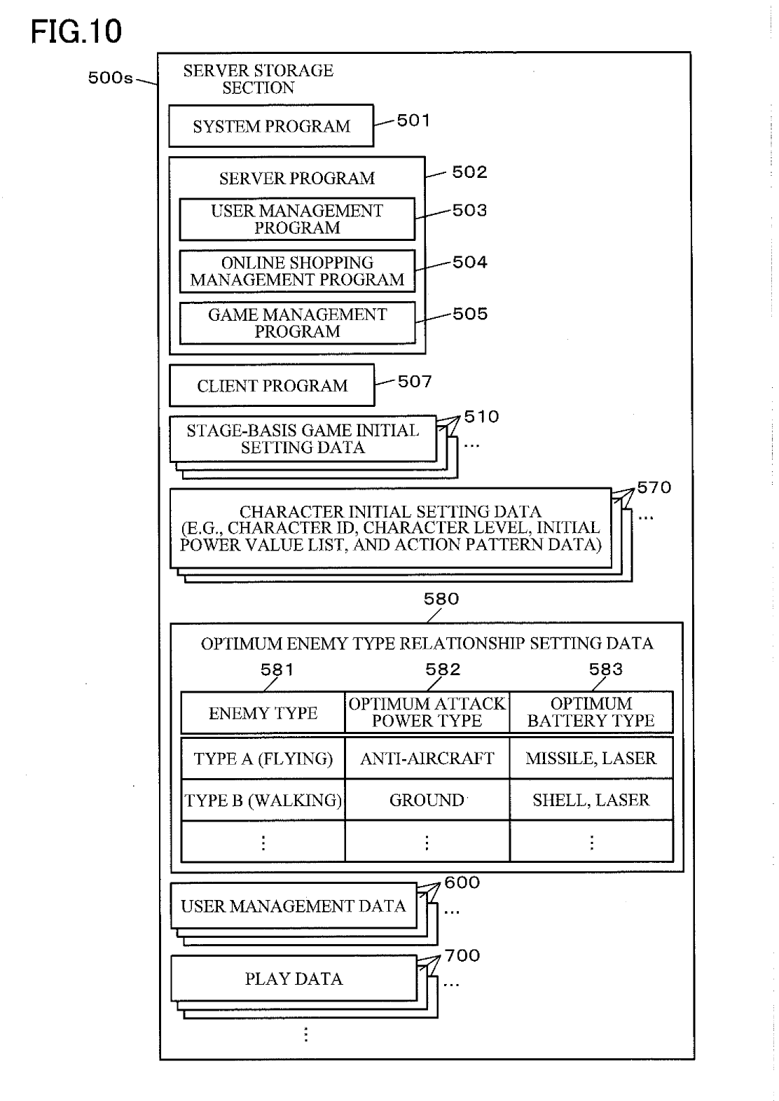

FIG. 10 is a view illustrating an example of a program and data stored in the server storage section 500s according to one embodiment of the invention.

The server storage section 500s stores a system program 501, a server program 502, a client program 507, stage-basis game initial setting data 510, character initial setting data 570, and optimum enemy type relationship setting data 580. The server storage section 500s also stores user management data 600 and play data 700 that are successively generated and updated. The server storage section 500s may also appropriately store additional information (e.g., timer value, counter value, and flag).

The system program 501 is a basic program that is read and executed by the server processing section 200s to implement a basic input-output function necessary for a computer.

The server program 502 is a program that implements the function of an online game server. In one embodiment of the invention, the server program 502 includes a user management program 503 that implements the function of the user management section 202, an online shopping management program 504 that implements the function of the online shopping management section 204, and a game management program 505 that implements the function of the game management section 210.

The client program 507 is a program that is executed by the player terminal 1500 to execute the game. The client program 507 may be implemented by a dedicated program, for example. When implementing the game according to one embodiment of the invention as a web game, the client program 507 may be implemented using web technology that actively controls screen display based on a web browser utilizing HTML, Java (registered trademark), Cascading Style Sheets (CSS), and the like, and a plug-in such as Adobe (registered trademark) Flash. Note that another method may also be used.

The stage-basis game initial setting data 510 is provided on a game stage basis, and includes various types of initial setting data necessary for executing the game in each stage. Part of the stage-basis game initial setting data 510 may be distributed to the player terminal 1500.

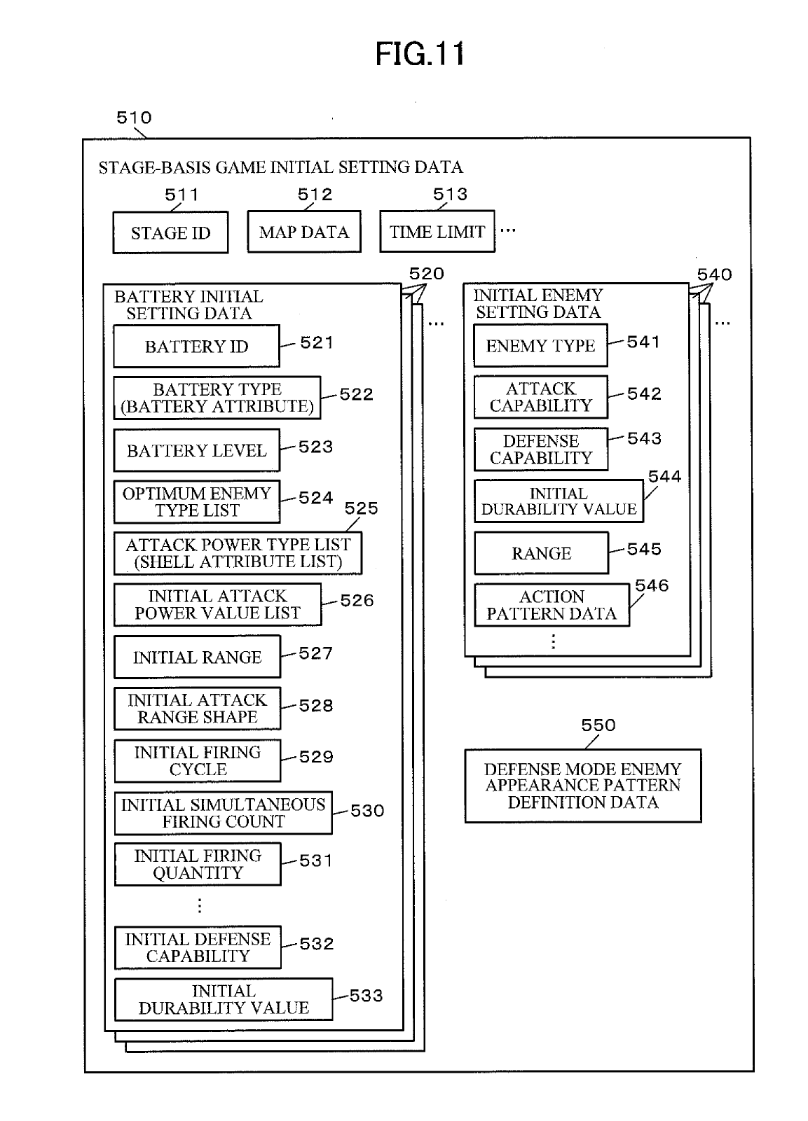

As illustrated in FIG. 11, the stage-basis game initial setting data 510 includes a stage ID 511, map data 512, a time limit 513 that is used as a game clear determination criterion, battery initial setting data 520, enemy initial setting data 540, and defense mode enemy appearance pattern definition data 550, for example. Note that the stage-basis game initial setting data 510 may include additional data depending on the game.

The battery initial setting data 520 is provided corresponding to each battery 16 that can be placed on the map 10 in the corresponding stage. The battery initial setting data 520 includes a battery ID 521 specific to the battery 16, a battery type 522, a battery level 523, an optimum enemy type list 524, an attack power type list 525, an initial attack power value list 526, an initial range 527, an initial attack range shape 528, an initial firing cycle 529, an initial simultaneous firing count 530, an initial firing quantity 531, an initial defense capability 532, and an initial durability value 533. Note that the battery initial setting data 520 may optionally include additional data (e.g., data for displaying the battery 16 within the game screen).

The battery type 522 represents the type of the battery 16. In one embodiment of the invention, the battery type 522 represents one of the shell battery 16C, the missile battery 16M, and the laser battery 16L (see FIG. 3). Note that the battery type 522 represents the attribute assigned to the battery 16 depending on the game.

The optimum enemy type list 524 includes an enemy type (attack target enemy type) to which damage can be effectively applied taking account of the attack power assigned to the battery 16. In one embodiment of the invention, the walking-type enemy 14A is set as the enemy type corresponding to the shell battery 16C that has an excellent ground attack capability, and the flying-type enemy 14B is set as the enemy type corresponding to the missile battery 16M that has an excellent anti-aircraft attack capability (see FIG. 3).

The attack power type list 525 represents the type and the attribute of a single attack power or a plurality of attack powers assigned to the battery 16. In one embodiment of the invention, the attack power type “ground, shell” is set corresponding to the shell battery 16C, the attack power type “anti-aircraft, missile” is set corresponding to the missile battery 16M, and the attack power type “ground+anti-aircraft, laser” is set corresponding to the laser battery 16L. The attack power type list 525 represents the shell attribute depending on the game. For example, when magic is used in the game world, and an attack is made using magic, magic attributes “flame”, “freeze”, “thunder”, “spirit”, and the like may be used.

The initial attack power value list 526 is a list of the power values of each attack power assigned to the battery 16. The power values are stored in a predetermined order (e.g., ground attack capability→anti-aircraft attack capability). For example, when the ground attack capability is “10”, and the anti-aircraft attack capability is “40”, the power values “10, 40” are stored in this order.

The initial firing quantity 531 represents (defines) the upper-limit firing quantity corresponding to the battery type. For example, the initial firing quantity 531 represents (defines) the number of shells corresponding to the shell battery 16C, represents the number of missiles corresponding to the missile battery 16M, and represents the cumulative emission count or the cumulative operating time corresponding to the laser battery 16L.

The enemy initial setting data 540 is provided corresponding to the type of enemy 14 that appears in the stage.

The enemy initial setting data 540 includes an enemy type 541, an attack capability 542, a defense capability 543, an initial durability value 544, a range 545, and action pattern data 546. Note that the enemy initial setting data 540 may optionally include additional data (e.g., data for displaying the enemy 14 within the game screen).

The defense mode enemy appearance pattern definition data 550 represents (defines) the position on the map 10 and the timing at which the enemy is caused to appear in the stage, and the type and the number of enemies that are caused to appear in the stage.

Again referring to FIG. 10, the character initial setting data 570 is initial setting data that relates to the invasion object that is used by the player when the player plays the game in the capture mode.

In one embodiment of the invention, the character initial setting data 570 represents the initial setting values of the character 4 that is assigned to the game card 3 (see FIG. 1), and the character 4 that can be purchased by online shopping. For example, the character initial setting data 570 includes a character ID, a character level, an initial power value list, and action pattern data. Note that the character initial setting data 570 may optionally include additional data (e.g., data for displaying the character 4 within the game screen).

The optimum enemy type relationship setting data 580 represents (defines) the optimum enemy type relationship. For example, the optimum enemy type relationship setting data 580 includes an enemy type 581 (that represents the type of enemy 14), an optimum attack power type 582 (that represents the attack power that can effectively damage the enemy 14 that corresponds to the enemy type 581), and an optimum battery type 583 (that represents the type of battery 16 to which the attack power represented by the optimum attack power type 582 is assigned) in a linked manner.

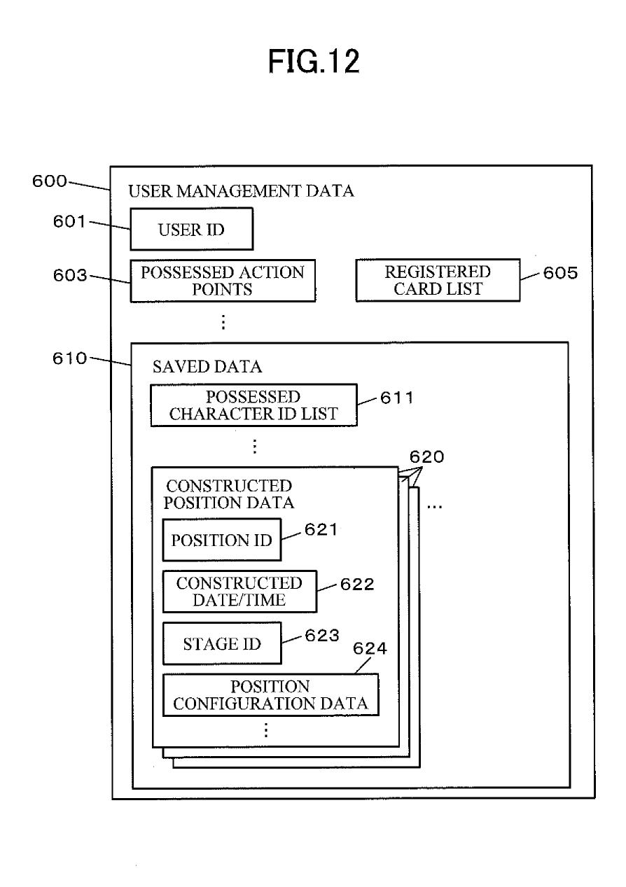

The user management data 600 is provided corresponding to each player who has registered himself/herself as a user. As illustrated in FIG. 12, the user management data 600 includes a user ID 601, possessed action points 603, a registered card list 605, and saved data 610, for example. Note that the user management data 600 may optionally include additional data.

The saved data 610 includes a possessed character ID list 611 (i.e., a list of the characters 4 possessed by the player), and constructed position data 620 that is generated each time a position is constructed in the defense mode. Note that the saved data 610 may optionally include additional data depending on the game.

The constructed position data 620 includes a position ID 621, a constructed date/time 622, a stage ID 623, and position configuration data 624. Note that the constructed position data 620 may optionally include additional data.

The position configuration data 624 represents the results of the operation inputs performed using the position construction screen W4 (see FIG. 4). Specifically, the position configuration data 624 represents the placeable element (battery 16) that has been placed on the map 10, and the position on the map 10 at which the placeable element (battery 16) has been placed in the stage represented by the stage ID 623.

Again referring to FIG. 10, the play data 700 is provided corresponding to the game that is being played, and includes various types of data that represents the game status (i.e., the progress of the game).

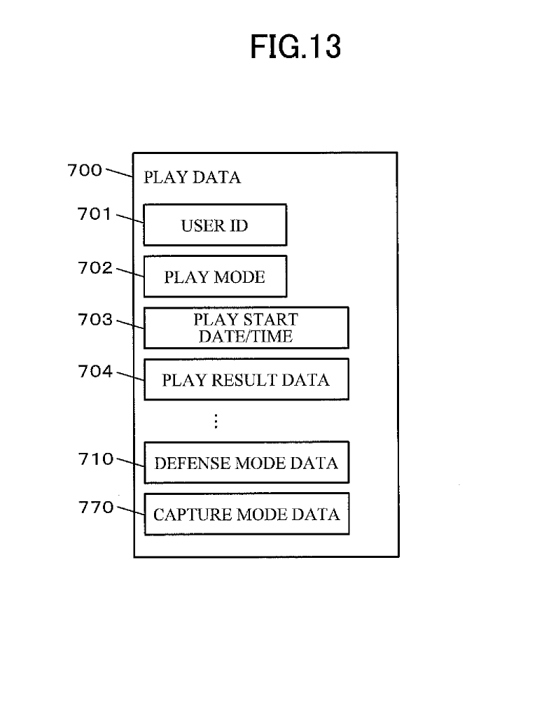

As illustrated in FIG. 13, the play data 700 includes a user ID 701 that represents the player, a play mode 702, a play start date/time 703, play result data 704, and defense mode data 710 or capture mode data 770, for example. Note that the play data 700 may optionally include additional data.

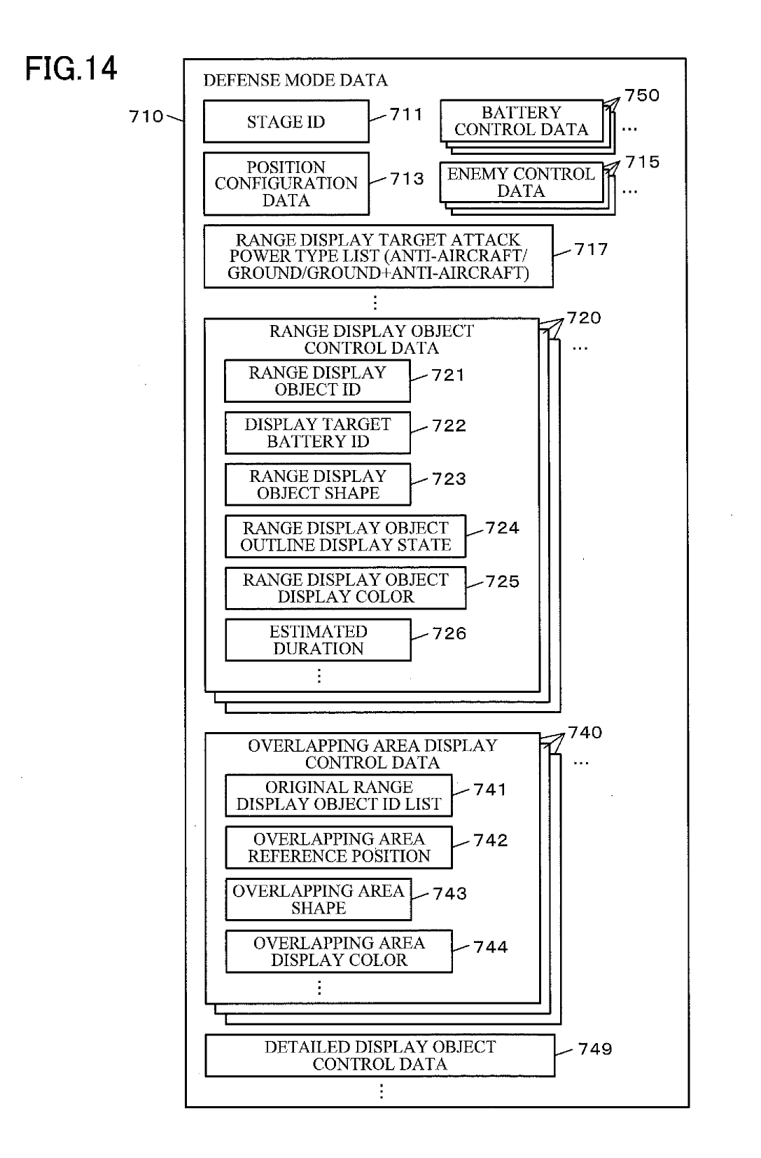

FIG. 14 is a view illustrating a data configuration example of the defense mode data 710.

The defense mode data 710 includes a stage ID 711, position configuration data 713, battery control data 750, enemy control data 715, a range display target attack power type list 717, range display object control data 720, overlapping area display control data 740, and detailed display object control data 749. Note that the defense mode data 710 may optionally include additional data.

The position configuration data 713 represents the results of the operation inputs performed using the position construction screen W4 (see FIG. 4). Specifically, the position configuration data 713 represents the placeable element (battery 16) that has been placed on the map 10, and the position on the map 10 at which the placeable element (battery 16) has been placed in the stage represented by the stage ID 623. The position configuration data 713 is copied to the constructed position data 620 included in the saved data 610 as the position configuration data 624 when the defense mode has ended.

The battery control data 750 is provided corresponding to each battery 16 that has been placed on the placement setting map 34 using the position construction screen W4 (see FIG. 4), and includes various types of data that represents the state of the battery 16 during the game.

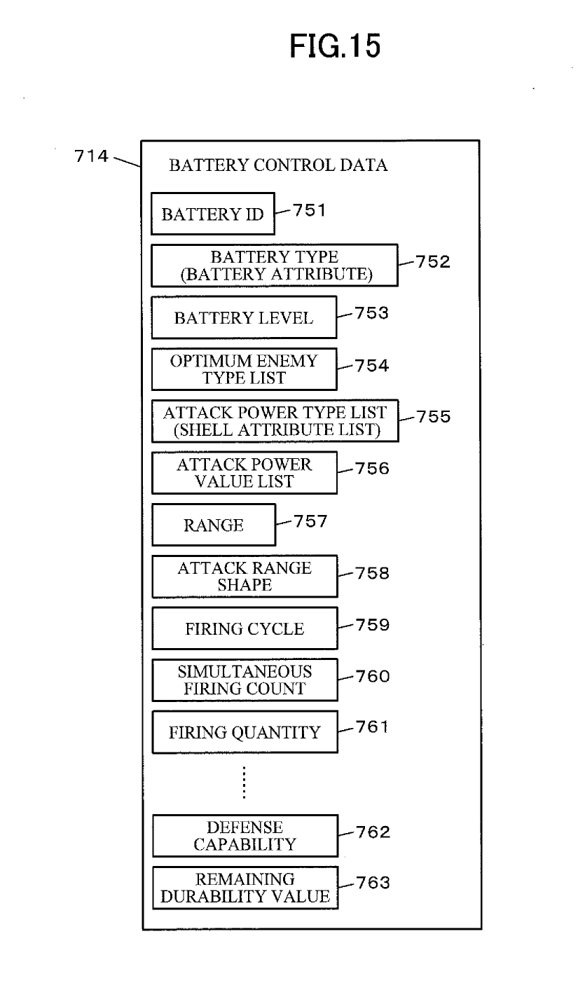

As illustrated in FIG. 15, the battery control data 750 includes a battery ID 751, a battery type 752, a battery level 753, an optimum enemy type 754, an attack power type list 755, an attack power value list 756, a range 757, an attack range shape 758, a firing cycle 759, a simultaneous firing count 760, a firing quantity 761, a defense capability 762, and a remaining durability value 763, for example. Note that the battery control data 750 may optionally include additional data (e.g., data for displaying the battery 16 within the game screen).

These pieces of data are copied from the battery initial setting data 520 included in the stage-basis game initial setting data 510 (see FIG. 11) that corresponds to the stage ID 711 prior to the start of the game. For example, the initial durability value 533 is copied to the remaining durability value 763. A firing cycle counter, display control data for displaying the battery 16 within the game screen, and the like are additionally provided.

Again referring to FIG. 14, the enemy control data 715 is provided corresponding to each enemy 14 that has appeared on the map 10, and includes various types of data that represents the position and the state of the enemy 14, display control data for displaying the enemy 14 within the game screen, and the like. The enemy control data 715 is copied from the battery initial setting data 520 included in the stage-basis game initial setting data 510 (see FIG. 11) that corresponds to the stage ID 711 prior to the start of the game, and the remaining durability value, the firing cycle counter, display control data for displaying the battery 16 within the game screen, and the like are additionally provided.

The range display target attack power type list 717 is a list of the attack powers displayed using the range display object 20.

In one embodiment of the invention, the type of attack power is set to “ground” when the player has touched the ground attack range display operation icon 41, set to “anti-aircraft” when the player has touched the anti-aircraft attack range display operation icon 42, and set to “ground” and “anti-aircraft” when the player has touched the ground attack+anti-aircraft attack range display operation icon 43.

When the player has touched the first optimum enemy type attack range display operation icon 44, the optimum attack power type 582 that corresponds to the enemy type 581 linked to the icon is automatically selected (set) according to the optimum enemy type relationship setting data 580 (see FIG. 10). In one embodiment of the invention, the optimum attack power type is set to “anti-aircraft”. Likewise, the optimum attack power type is set to “ground” when the player has touched the second optimum enemy type attack range display operation icon 45 (see FIG. 4).

The optimum attack power type is set to “ground” and “anti-aircraft” when the player has touched the safety zone display operation icon 46 (see FIG. 7).

The range display object control data 720 is provided corresponding to each range display object 20, and includes information about the display control process on the range display object 20 (see FIG. 5). In one embodiment of the invention, the range display object control data 720 includes a range display object ID 721, a display target battery ID 722, a range display object shape 723, a range display object outline display state 724, a range display object display color 725, and an estimated duration 726. Note that the range display object control data 720 may optionally include additional data.

The overlapping area display control data 740 is provided corresponding to each overlapping area 22, and includes various types of data for displaying the overlapping area 22 in an identifiable manner (see FIG. 5). In one embodiment of the invention, the overlapping area display control data 740 includes an original range display object list 741 that represents the range display objects 20 that overlap each other, an overlapping area reference position 742 that represents the reference position coordinates of the overlapping area, an overlapping area shape 743, and an overlapping area display color 744. Note that the overlapping area display control data 740 may optionally include additional data. For example, the overlapping area display control data 740 may include information about the transparency of the overlapping area.

The detailed display object control data 749 includes various types of data for controlling the display of the detailed display object 23 (see FIG. 6).

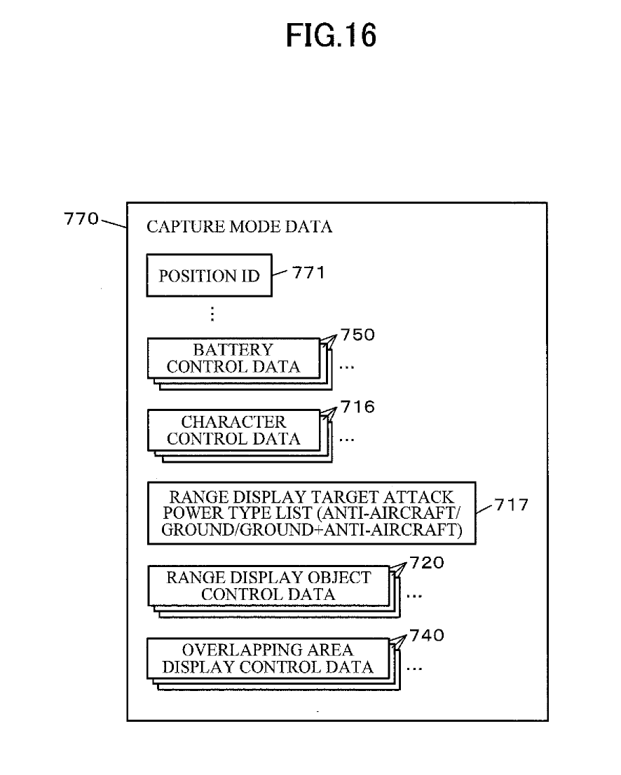

FIG. 16 is a view illustrating a data configuration example of the capture mode data 770.

The capture mode data 770 includes a position ID 771, battery control data 750, character control data 716, a range display target attack power type list 717, range display object control data 720, and overlapping area display control data 740. Note that the capture mode data 770 may optionally include additional data.

### Flow of Process

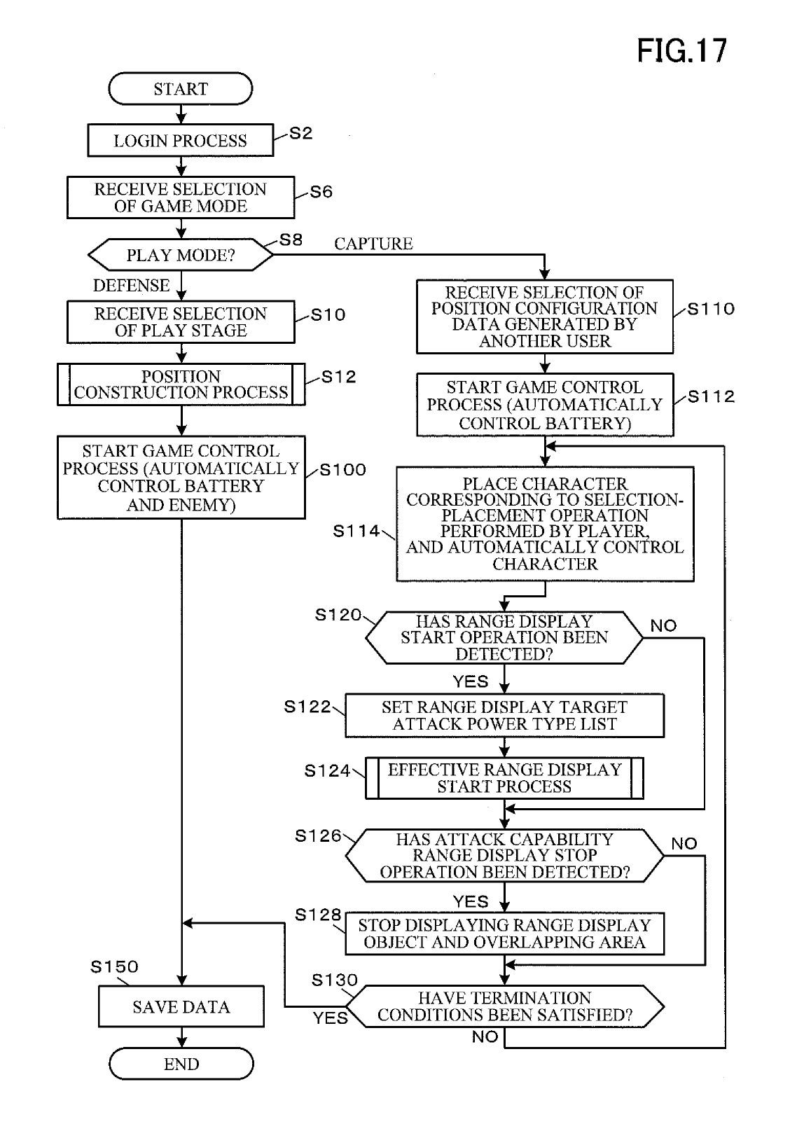

FIG. 17 is a flowchart illustrating the flow of the main process performed by the server system 1100. The process described below is implemented by causing the server system 1100 to execute the server program 502. Note that the following description is given on the assumption that the player has registered himself/herself as a user, and the player terminal 1500 operated by the player has executed the client program 507 to establish data communication with the server system 1100.

The server system 1100 performs the player login process (step S2), and allocates a storage area for the play data 700 that corresponds to the player. The server system 1100 then performs the process that receives the selection of the play mode (step S4).

When the defense mode has been selected (“DEFENSE” in step S8), the server system 1100 allocates a storage area for the defense mode data 710, and performs the process that receives the selection of the game stage (step S10). The selection result is stored as the stage ID 711 included in the defense mode data 710 (see FIG. 14). The server system 1100 then performs the position construction process (step S12).

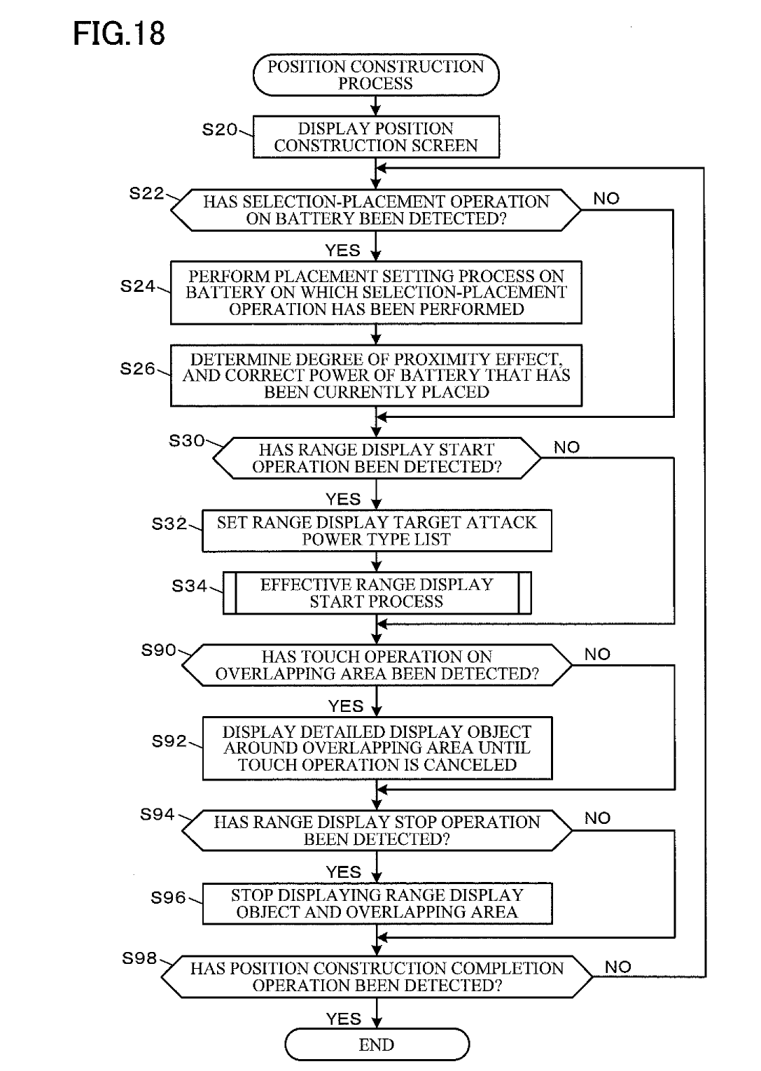

FIG. 18 is a flowchart illustrating the flow of the position construction process.

The server system 1100 displays the position construction screen W4 on the player terminal 1500 (step S20 (see FIG. 4)).

More specifically, the server system 1100 refers to the stage-basis game initial setting data 510 (see FIG. 11) that corresponds to the stage ID 711, displays the possessed action points 603 included in the user management data 600 (see FIG. 12) that corresponds to the player on the action point display 32, and displays the placement setting map 34 based on the map data 512. The server system 1100 displays the optimum enemy type attack range operation icon corresponding to each enemy type represented by the enemy initial setting data 540 as the range display operation icon group 40. The server system 1100 displays the placeable elements within the deck 38 corresponding to the battery initial setting data 520.

When the server system 1100 has detected that the player has performed the selection-placement operation on a specific battery 16 using the position construction screen W4 (YES in step S22), the server system 1100 performs the placement setting process on the battery 16 on which the selection-placement operation has been performed (step S24). Specifically, the server system 1100 generates the battery control data 750, and stores the battery ID and the placement position coordinates of the battery 16 (on which the selection-placement operation has been performed) so as to be linked to the position configuration data 713.

The server system 1100 then determines the degree of proximity effect based on the relative positional relationship between the battery 16 that has been previously placed and the battery 16 that has been currently placed, and corrects the power of the battery 16 that has been currently placed (step S26).

For example, the server system 1100 enhances the attack capability and the range by a factor of 1.5 when the battery 16 that is identical in type to the battery 16 that has been currently placed has been previously placed within a given distance range, and enhances the defense capability by a factor of 1.2 when the battery 16 that differs in type from the battery 16 that has been currently placed has been previously placed within a given distance range. It is desirable to enhance the power of the battery 16 that has been currently placed when a larger number of batteries 16 are situated closer to the battery 16 that has been currently placed. Note that the attack power may be decreased in order to increase the difficulty level of the game.

When the server system 1100 has detected that the player has touched one of the icons included in the range display operation icon group 40, the server system 1100 determines that the player has performed a range display start operation (YES in step S30), sets the range display target attack power type list 717 corresponding to the icon that has been touched (step S32 (see FIG. 14)), and performs an effective range display start process (step S34).

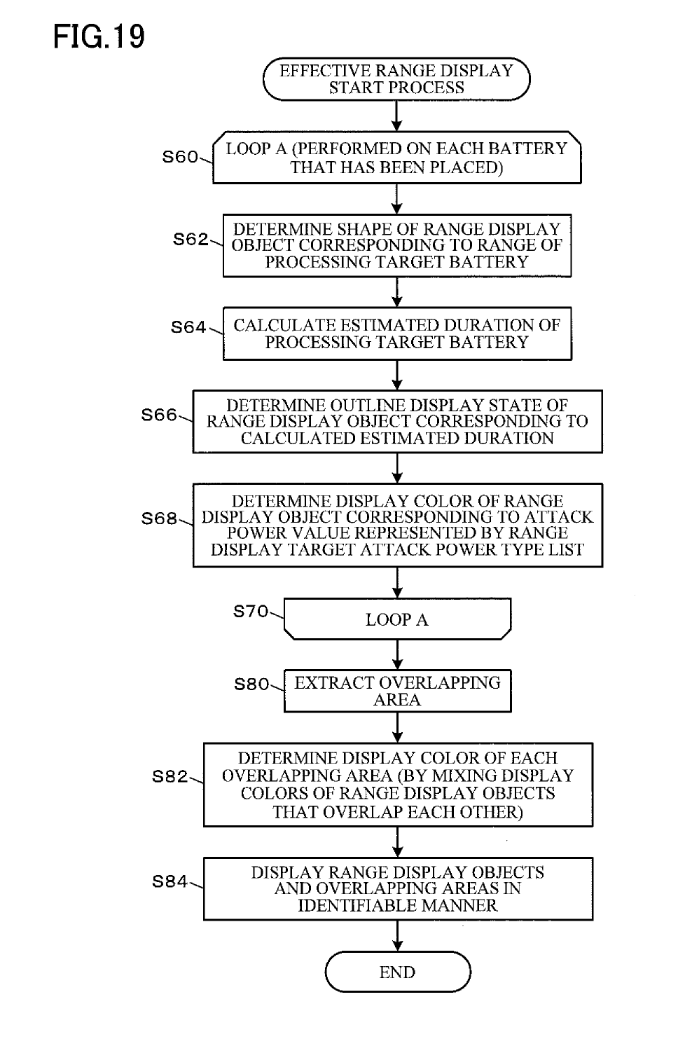

FIG. 19 is a flowchart illustrating the flow of the effective range display start process.

The server system 1100 performs a loop A process on each battery 16 that has been placed, and determines each control value included in the range display object control data 720 (see FIG. 14) for controlling the range display object 20 that corresponds to the processing target battery 16 (steps S60 to S70).

Specifically, the server system 1100 determines the range display object shape 723 included in the range display object control data 720 that corresponds to the range display object 20 that corresponds to the processing target battery 16 corresponding to the range 757 (see FIG. 15) included in the battery control data 750 that corresponds to the processing target battery 16 (step S62). For example, a scaling factor may be determined using a given function that uses the range 757 as a variable, and the attack range shape 758 included in the battery control data 750 that corresponds to the processing target battery 16 may be increased by the scaling factor.

The server system 1100 then calculates the estimated duration 726 of the processing target battery 16 (step S64), and determines the range display object outline display state 724 of the range display object 20 that corresponds to the processing target battery 16 corresponding to the calculated estimated duration (step S66 (see FIG. 5)).

The server system 1100 then determines the range display object display color 725 corresponding to the value of the attack power type represented by the range display target attack power type list 717 (step S66 (see FIG. 5)), and terminates the loop A process (step S70).

When the server system 1100 has performed the loop A process on all of the batteries 16 that have been placed, the server system 1100 extracts the overlapping area 22, generates the overlapping area display control data 740 (see FIG. 14) corresponding to each extracted overlapping area 22 (step S80), and determines the overlapping area display color 744 that corresponds to each overlapping area 22 by mixing the display colors of the range display objects 20 that overlap each other (step S82). When the transparency of the overlapping area 22 is also changed, it is desirable to decrease the transparency of the overlapping area 22 (increase the opacity of the overlapping area 22) as the number of range display objects 20 that overlap each other increases.

The server system 1100 then displays the range display objects 20 and the overlapping areas 22 on the placement setting map 34 within the position construction screen W4 in an identifiable manner (step S84), and terminates the effective range display start process.

Again referring to FIG. 17, when the server system 1100 has detected that the player has performed a touch operation on an arbitrary overlapping area 22 (YES in step S90), the server system 1100 displays the detailed display object 23 around the overlapping area 22 until the player terminates the touch operation (step S92).

When the server system 1100 has detected that the player has performed a range display stop operation within the position construction screen W4, the server system 1100 stops displaying the range display objects 20 and the overlapping areas 22 in an identifiable manner (step S96).

The server system 1100 repeats the steps S22 to S96 until the server system 1100 detects a given construction completion operation (NO in step S98). When the server system 1100 has detected the construction completion operation (YES in step S98), the server system 1100 terminates the position construction process.

The server system 1100 then starts the game control process in the defense mode (step S100) (see FIG. 17). Specifically, the battery 16 and the enemy 14 are automatically controlled, and the player enjoys watching a state in which the position constructed by the player holds out against the invasion by the enemies 14 (see FIG. 3).

When the game in the defense mode has ended, the server system 1100 updates the saved data 610 (e.g., adds new constructed position data 620 based on the position configuration data 713 included in the defense mode data 710 (see FIG. 14)) (step S150), and terminates the process.

When the capture mode has been selected (“CAPTURE” in step S8), the server system 1100 generates the capture mode data 770 (see FIG. 16), and allows the player to select the capture target position (step S110).

For example, the server system 1100 extracts a given number of positions from the constructed position data 620 (see FIG. 12) included in the user management data 600 that corresponds to another player, displays a list of the extracted positions on the player terminal 1500, and allows the player to select the capture target position from the list. If it is impossible to extract a position from the constructed position data 620, the server system 1100 automatically generates several positions, and allows the player to select the capture target position. The selection result is stored as the position ID 771 included in the capture mode data 770.

The server system 1100 then displays the capture mode game screen W6 (see FIG. 7) on the player terminal 1500, and starts the game control process in the capture mode (step S112). Specifically, the server system 1100 generates a game field within the object space based on the position configuration data 624 included in the constructed position data 620 that corresponds to the position ID 771, and automatically controls the batteries 16 placed within the object space.

When the game in the capture mode has started, the characters 4 that are registered in the possessed character ID list 611 included in the saved data 610 that corresponds to the player are displayed within the deck 38 displayed within the capture mode game screen W6. The player can place the desired character 4 displayed within the deck 38 at an arbitrary position by performing a drag-and-drop operation that moves the character 4 to the map 10.

The server system 1100 places the character 4 on the map 10 corresponding to the selection-placement operation performed on the character 4, and automatically controls the character 4 (step S114). The character 4 is controlled to move toward the base 12 while attacking the battery 16 in its action pattern in the same manner as the enemy 14 in the defense mode.

When the server system 1100 has detected that the player has touched one of the icons included in the range display operation icon group 40 (see FIG. 7) in the capture mode (YES in step S120), the server system 1100 sets the range display target attack power type list 717 included in the capture mode data 770 corresponding to the icon that has been touched (step S122), and performs the effective range display start process (step S124).

When the server system 1100 has detected that the player has performed the range display stop operation in the capture mode (YES in step S126), the server system 1100 stops displaying the range display objects 20 and the overlapping areas 22 in an identifiable manner (step S128).

The server system 1100 repeats the steps S114 to S128 until the game termination conditions in the capture mode are satisfied (NO in step S130). When the game termination conditions have been satisfied (YES in step S130), the server system 1100 terminates the process.

When the game is designed so that the power of the character 4 that has been used is changed based on the play result data 704 (growth process), it is desirable to terminate the process after appropriately performing the growth process on the character 4 after the game termination conditions have been satisfied.

According to the embodiments of the invention, it is possible to improve the attraction of the game that proceeds corresponding to the arrangement of the bombardment objects that have been placed by the user by displaying the effective ranges of a plurality of batteries 16 (bombardment objects) and the overlapping areas thereof so that the user can easily determine the effective ranges and the overlapping areas. Since it is possible to visually provide the information about the power (for which the range is displayed) by changing the size, the display state, and the like of the range display object 20, even an inexperienced player and a junior player become aware of a strategic viewpoint and a strategic idea that are important for the game according to the embodiments of the invention. Therefore, the game according to the embodiments of the invention is significantly user-friendly as compared with a known game that does not have such a feature, and it is possible to provide a more interesting game.

### Modifications

The embodiments to which the invention is applied have been described above.

Note that the invention is not limited to the above embodiments. Various modifications may be appropriately made, such as adding other elements, omitting some of the elements, or changing some of the elements.

Although the above embodiments have been described taking an example in which the game to which the invention is applied is implemented as an online tower defense game (defense game), the game to which the invention is applied may be implemented as a stand-alone game that can be executed by the player terminal 1500. In this case, the functional configuration illustrated in FIG. 9 is implemented by the player terminal 1500, and the process performed by the server system 1100 in the flowcharts illustrated in FIGS. 17 to 19 is performed by the player terminal 1500.

Although the above embodiments have been described taking the tower defense game as an example, the invention may also be applied to a game that belongs to another genre as long as the game is designed to proceed according to the arrangement of the bombardment objects that have been placed by the user.

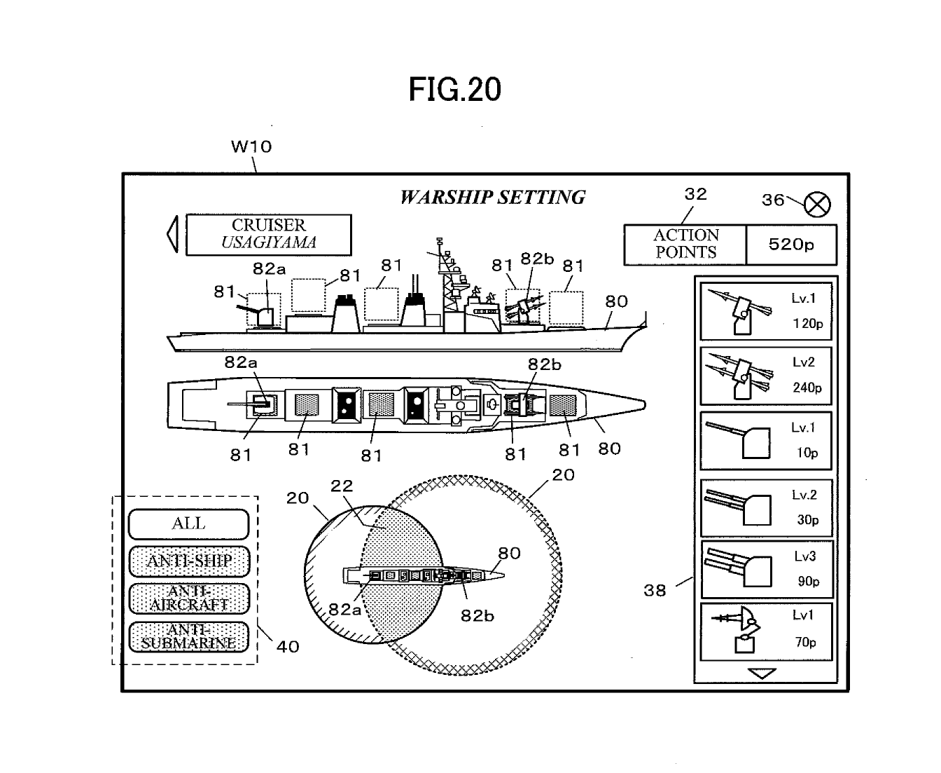

For example, the invention may be applied to a fleet battle simulation game as illustrated in FIG. 20 that is designed so that the player places a placeable element (e.g., an anti-ship gun unit 82a, an anti-aircraft unit 82b that fires an anti-aircraft missile, an anti-submarine unit, and an electronic warfare unit) that corresponds to the battery 16 used in connection with the above embodiments at each placement position 81 of a combat ship 80 using a battle preparation screen W10. The invention may similarly be applied to a simulation RPG.

Although the above embodiments have been described taking an example in which the effective range of each battery 16 that has been placed on the placement setting map 34 is displayed when one of the icons included in the range display operation icon group 40 has been touched, a configuration in which the range display target can be selected may also be employed.

More specifically, the range display control section 216 (see FIG. 9) may be provided with the function of an attack object selection means that selects the attack object. The effective range display start process (see FIG. 19) may be modified so that a step that selects the power range (effective range) display target from the batteries 16 that have been placed on the placement setting map 34 is performed before the step S60, and the loop A process is performed on the battery 16 that has been selected by the above step.

Although the above embodiments have been described taking an example in which the effective range display is performed free of charge, a configuration in which the player is appropriately charged for the display of the effective range may also be employed.

More specifically, the range display control section 216 (see FIG. 9) may be provided with the function of a point consumption control means that controls the display of the effective range in exchange for the consumption of given points possessed by the user. The effective range display start process (see FIG. 19) may be modified so that a step that subtracts points that correspond to the number or the type of display target batteries 16 from the possessed action points 603 of the player, and a step that notifies the player that the player has been charged for the display of the effective range are performed after the step S84.

The types of operation icons 44 included in the range display operation icon group 40 is not limited to that described above in connection with the above embodiments. An arbitrary type of operation icon may be appropriately added or omitted. For example, the range display operation icon group 40 may include an operation icon that is linked to one type or a plurality of types of batteries 16, an operation icon that is linked to one type or a plurality of types of batteries 16 and one type or a plurality of types of enemies 14, and the like.

In this case, a range display target battery type list may be added to the defense mode data 710 (see FIG. 14) in the same manner as the range display target attack power type list 717, a step that changes the range display target battery type list corresponding to the type of operation icon for which an operation input has been detected may be added to follow the step S122 illustrated in FIG. 17, and the loop A process (see FIG. 19) may be performed on the batteries 16 included in the range display target battery type list.

Although only some embodiments of the invention have been described in detail above, those skilled in the art would readily appreciate that many modifications are possible in the embodiments without materially departing from the novel teachings and advantages of the invention. Accordingly, all such modifications are intended to be included within the scope of the invention.

1. A method that causes a computer system to control display of a game image on a display device, the method comprising:
placing an attack object at a designated placement position within an object space according to a placement operation performed by a user;
displaying an effective range of an attack power of the attack object within the object space;
displaying an overlapping area of the effective ranges that respectively correspond to a plurality of the attack objects in an identifiable manner; and
performing a game control process according to an arrangement of the attack object.

2. The method as defined in claim 1, further comprising:
changing a size of the effective range corresponding to a range of the attack object.

3. The method as defined in claim 1, further comprising:
displaying the effective range in an identifiable manner corresponding to one of a type of the attack object, compatibility of the attack object with an attack target, an attack attribute assigned to the attack object, and an attack quantity assigned to the attack object, the type, the compatibility, the attack attribute, and the attack quantity being hereinafter referred to as “type or the like”.

4. The method as defined in claim 3, further comprising:
displaying an area of the effective range other than the overlapping area corresponding to the type or the like of the attack object, and displaying the overlapping area corresponding to the type or the like of the attack object that corresponds to the overlapping area.

5. The method as defined in claim 1, further comprising:
selecting the attack object; and
displaying the effective range of only the selected attack object.

6. The method as defined in claim 3, further comprising:
selecting the attack object; and
displaying the effective range of only the selected attack object corresponding to the type or the like of the selected attack object.

7. The method as defined in claim 1, further comprising:
controlling display of the object space in which the attack object has been placed by a first user based on a display instruction operation performed by a second user.

8. The method as defined in claim 1, further comprising:
displaying the effective range, or displaying the overlapping area in an identifiable manner, or displaying the effective range and displaying the overlapping area in an identifiable manner in exchange for consumption of given points possessed by the user.

9. The method as defined in claim 8, further comprising:
changing a quantity of the points to be consumed corresponding to a number of the attack objects to be displayed or a type of the attack object to be displayed.

10. A server system that performs a game control process according to an arrangement of an attack object placed by a user according to an operation performed on a user terminal that is communicably connected thereto, and controls display of a game image on the user terminal, the server system comprising:
a placement section that places the attack object at a designated placement position within an object space according to a placement operation performed using the user terminal; and
a display control section that performs a control process that causes the user terminal to display an effective range of an attack power of the attack object within the object space, the display control section displaying an overlapping area of the effective ranges that respectively correspond to a plurality of the attack objects in an identifiable manner.

11. A server system that performs a game control process according to an arrangement of an attack object placed by a user according to an operation performed on a user terminal that is communicably connected thereto, and controls display of a game image on the user terminal, the server system comprising:
placement means that places the attack object at a designated placement position within an object space according to a placement operation performed using the user terminal; and
display control means that performs a control process that causes the user terminal to display an effective range of an attack power of the attack object within the object space, the display control means displaying an overlapping area of the effective ranges that respectively correspond to a plurality of the attack objects in an identifiable manner.

12. The method as defined in claim 2, further comprising:
displaying the effective range in an identifiable manner corresponding to one of a type of the attack object, compatibility of the attack object with an attack target, an attack attribute assigned to the attack object, and an attack quantity assigned to the attack object, the type, the compatibility, the attack attribute, and the attack quantity being hereinafter referred to as “type or the like”.

13. The method as defined in claim 12, further comprising:
displaying an area of the effective range other than the overlapping area corresponding to the type or the like of the attack object, and displaying the overlapping area corresponding to the type or the like of the attack object that corresponds to the overlapping area.

14. The method as defined in claim 2, further comprising:
selecting the attack object; and
displaying the effective range of only the selected attack object.

15. The method as defined in claim 12, further comprising:
selecting the attack object; and
displaying the effective range of only the selected attack object corresponding to the type or the like of the selected attack object.

16. The method as defined in claim 2, further comprising:
controlling display of the object space in which the attack object has been placed by a first user based on a display instruction operation performed by a second user.

17. The method as defined in claim 2, further comprising:
displaying the effective range, or displaying the overlapping area in an identifiable manner, or displaying the effective range and displaying the overlapping area in an identifiable manner in exchange for consumption of given points possessed by the user.

18. The method as defined in claim 17, further comprising:
changing a quantity of the points to be consumed corresponding to a number of the attack objects to be displayed or a type of the attack object to be displayed.
